(19) United States
(12) Patent Application Publication
(10) Pub. No.: US 2008/0203012 A1
(43) Pub. Date: Aug. 28, 2008

(54) MEMBRANE, APPARATUS, AND ASSOCIATED METHOD

(75) Inventors: Gary William Yeager, Rexford, NY (US); Daniel Steiger, Clifton Park, NY (US); Joseph Anthony Suriano, Clifton Park, NY (US); Yanshi Zhang, Schenectady, NY (US); Sharon Oba, Clifton Park, NY (US)

Correspondence Address: CANTOR COLBURN LLP - SABIC (NORYL), 20 Church Street, 22nd Floor, Hartford, CT, 06103, US

(73) Assignee: GENERAL ELECTRIC COMPANY, Schenectady, NY (US)

(21) Appl. No.: 11/677,848

(22) Filed: Feb. 22, 2007

(51) Int. Cl. B01D 39/16; B01D 71/38; C08G 65/00; C08G 73/00; C08G 73/06; C08G 75/00; C08G 79/02

(52) U.S. Cl. 210/500.36; 528/373; 528/398; 528/422; 528/423; 528/425

(57) ABSTRACT

A membrane is provided that is formed from a composition. The composition comprises a polyarylene ether polymer or copolymer comprising a zwitterion; or comprises a polyarylene polymer or copolymer comprising a zwitterion.

### BACKGROUND

1. Technical Field

The invention includes embodiments that relate to a composition. The invention includes embodiments that relate to method of using the composition and related article. The invention includes embodiments that relate to a membrane.

2. Discussion of Art

The properties and characteristics of membranes depend at least in part on the nature of the material from which the membrane is made. Membranes with good hydrophilicity, wetability, porosity and chemical resistance find use in applications such as filtration applications including ultrafiltration, microfiltration, hyperfiltration, hemofiltration and hemodialysis. Fouling of membranes by proteins and cells can negatively impact the flux and selectivity of porous membranes. In applications in which porous membranes are brought into contact with body fluids, immunogenicity and thrombosis are concerns. For example in blood filtration applications, such as hemodialysis, the binding of the protein fibrinogen and consequential platelet cell adhesion mark the initial stages of thrombosis. Thus, biocompatibility, including hemocompatibility, is desirable in porous membranes. One indication of biocompatiblity or hemocompatibility is the degree to which a material is hydrophilic. Generally, hydrophilic membranes show low protein binding resulting in increased levels of blood compatibility and/or lower levels of fouling than a hydrophobic membrane. Thus, hydrophilicity is an indication that a material may have some utility, for example, as a biocompatible membrane or hemocompatible membrane. Hemocompatibility is the property where the fibrinogen contained in the blood or blood fluid component in contact with the hemocompatible surface has a reduced tendency to bind to the surface to reduce blood coagulation. Biocompatibility is the property of a material to perform a function within a mammal in a specific application.

It may be desirable to have a composition with properties and characteristics that differ from those properties of currently available compositions. It may be desirable to have a composition produced by a method that differs from those methods currently available. It may be desirable to have a membrane with properties that differ from those properties of currently available membranes. It may be desirable to have a membrane produced by a method that differs from those methods currently available.

### BRIEF DESCRIPTION

In one embodiment, a membrane is provided that is formed from a composition. The composition comprises a polyarylene ether polymer or copolymer comprising a zwitterion; or comprises a polyarylene polymer or copolymer comprising a zwitterion.

In one embodiment, a water treatment system including the membrane is provided. The membrane is a filtration membrane that passes a flow of water from an aqueous solution of relatively high solute concentration to a solution of relatively low solute concentration in response to a pressure differential across the membrane.

In one embodiment, a desalination unit including the water treatment system is provided. In one embodiment, an ultrafiltration membrane is provided. The ultrafiltration membrane includes the membrane and a surface layer. The surface layer includes a reaction product of m-phenylene diamine and trimesoyl chloride.

In one embodiment, a separation unit includes a plurality of hollow fiber membranes. At least one of the plurality of membranes includes a membrane formed from poly alkylene oxide graft copolymer or a poly arylene oxide graft copolymer. The graft copolymer includes a Zwitterion.

In one embodiment, a hemodialysis apparatus includes the membrane. The hemodialysis apparatus can separate one blood component from another blood component. In one embodiment, a bioseparation apparatus includes the membrane. The bioseparation apparatus can separate one biological fluid component from another biological fluid component.

### DETAILED DESCRIPTION

The invention includes embodiments that relate to a composition. The invention includes embodiments that relate to method of making and/or using the composition and of making and/or using an article made from the composition, such as a membrane.

In one embodiment according to the invention, a polyarylene ether graft copolymer composition includes a member selected from a zwitterionic group, a polyalkylene ether group, or an amide group. These groups may be bound either within the polymer chain or may be pendant to it.

Aliphatic radical, aromatic radical and cycloaliphatic radical are defined as follows: An aliphatic radical is an organic radical having at least one carbon atom, a valence of at least one, and is a linear or branched bonded array of atoms. Aliphatic radicals may include heteroatoms such as nitrogen, sulfur, silicon, selenium and oxygen or may be composed exclusively of carbon and hydrogen. Aliphatic radical may include a wide range of functional groups such as alkyl groups, alkenyl groups, alkynyl groups, halo alkyl groups, conjugated dienyl groups, alcohol groups, ether groups, aldehyde groups, ketone groups, carboxylic acid groups, acyl groups (for example, carboxylic acid derivatives such as esters and amides), amine groups, nitro groups and the like. For example, the 4-methylpent-1-yl radical is a C₆ aliphatic radical including a methyl group, the methyl group being a functional group, which is an alkyl group. Similarly, the 4-nitrobut-1-yl group is a C₄ aliphatic radical including a nitro group, the nitro group being a functional group. An aliphatic radical may be a haloalkyl group that includes one or more halogen atoms, which may be the same or different. Halogen atoms include, for example; fluorine, chlorine, bromine, and iodine. Aliphatic radicals having one or more halogen atoms include the alkyl halides: trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals include allyl, aminocarbonyl (—CONH₂), carbonyl, dicyanoisopropylidene —CH₂C(CN)₂CH₂—), methyl (—CH₃), methylene (—CH₂—), ethyl, ethylene, formyl (—CHO), hexyl, hexamethylene, hydroxymethyl (—CH₂OH), mercaptomethyl (—CH₂SH), methylthio (—SCH₃), methylthiomethyl (—CH₂SCH₃), methoxy, methoxycarbonyl (CH₃OCO—), nitromethyl (—CH₂NO₂), thiocarbonyl, trimethylsilyl ((CH₃)₃Si—), t-butyldimethylsilyl, trimethoxysilylpropyl ((CH₃O)₃SiCH₂CH₂CH₂—), vinyl, vinylidene, and the like. By way of further example, a “C₁-C₃₀ aliphatic radical” contains at least one but no more than 30 carbon atoms. A methyl group (CH₃—) is an example of a C₁ aliphatic radical. A decyl group (CH₃(CH₂)₉—) is an example of a C₁₀ aliphatic radical.

An aromatic radical is a bonded array of atoms having a valence of at least one and having at least one portion of the bonded array that forms an aromatic group. This bonded array may include heteroatoms such as nitrogen, sulfur, selenium, silicon and oxygen, or may be composed exclusively of carbon and hydrogen. Suitable aromatic radicals may include phenyl, pyridyl, furanyl, thienyl, naphthyl, phenylene, and biphenyl radicals. The aromatic group may be a cyclic structure having 4n+2 “delocalized” electrons where “n” is an integer equal to 1 or greater, as illustrated by phenyl groups (n=1), thienyl groups (n=1), furanyl groups (n=1), naphthyl groups (n=2), azulenyl groups (n=2), anthracenyl groups (n=3) and the like. The aromatic radical also may include non-aromatic components. For example, a benzyl group may be an aromatic radical, which includes a phenyl ring (the aromatic group) and a methylene group (the non-aromatic component). Similarly a tetrahydronaphthyl radical is an aromatic radical including an aromatic group (C₆H₃) fused to a non-aromatic component —(CH₂)₄—. An aromatic radical may include one or more functional groups, such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylphenyl radical is a C₇ aromatic radical including a methyl group, the methyl group being a functional group, which is an alkyl group. Similarly, the 2-nitrophenyl group is a C6 aromatic radical including a nitro group, the nitro group being a functional group. Aromatic radicals include halogenated aromatic radicals such as trifluoromethylphenyl, hexafluoroisopropylidenebis(4-phen-1-yloxy) (—OPhC(CF₃)₂PhO—), chloromethylphenyl, 3-trifluorovinyl-2-thienyl, 3-trichloromethylphen-1-yl (3-CCl₃Ph-), 4-(3-bromoprop-1-yl)phen-1-yl (BrCH₂CH₂CH₂Ph-), and the like. Further examples of aromatic radicals include 4-allyloxyphen-1-oxy, 4-aminophen-1-yl (H₂NPh-), 3-aminocarbonylphen-1-yl (NH₂COPh-), 4-benzoylphen-1-yl, dicyanoisopropylidenebis(4-phen-1-yloxy) (—OPhC(CN)₂PhO—), 3-methylphen-1-yl, methylenebis(phen-4-yloxy) (—OPhCH₂PhO—), 2-ethylphen-1-yl, phenylethenyl, 3-formyl-2-thienyl, 2-hexyl-5-furanyl; hexamethylene-1,6-bis(phen-4-yloxy) (—OPh(CH₂)₆PhO—), 4-hydroxymethylphen-1-yl (4-HOCH₂Ph-), 4-mercaptomethylphen-1-yl (4-HSCH₂Ph-), 4-methylthiophen-1-yl (4-CH₃SPh-), 3-methoxyphen-1-yl, 2-methoxycarbonylphen-1-yloxy (e.g., methyl salicyl), 2-nitromethylphen-1-yl (-PhCH₂NO₂), 3-trimethylsilylphen-1-yl, 4-t-butyldimethylsilylphenl-1-yl, 4-vinylphen-1-yl, vinylidenebis(phenyl), and the like. The term “a C₃-C₃₀ aromatic radical” includes aromatic radicals containing at least three but no more than 30 carbon atoms. The aromatic radical 1-imidazolyl (C₃H₂N₂—) represents a C₃ aromatic radical. The benzyl radical (C₇H₇—) represents a C₇ aromatic radical.

A cycloaliphatic radical is a radical having a valence of at least one, and having a bonded array of atoms that is cyclic but which is not aromatic. A cycloaliphatic radical may include one or more non-cyclic components. For example, a cyclohexylmethyl group (C₆H₁₁CH₂—) is a cycloaliphatic radical, which includes a cyclohexyl ring (the array of atoms, which is cyclic but which is not aromatic) and a methylene group (the noncyclic component). The cycloaliphatic radical may include heteroatoms such as nitrogen, sulfur, selenium, silicon and oxygen, or may be composed exclusively of carbon and hydrogen. A cycloaliphatic radical may include one or more functional groups, such as alkyl groups, alkenyl groups, alkynyl groups, halo alkyl groups, conjugated dienyl groups, alcohol groups, ether groups, aldehyde groups, ketone groups, carboxylic acid groups, acyl groups (for example carboxylic acid derivatives such as esters and amides), amine groups, nitro groups and the like. For example, the 4-methylcyclopent-1-yl radical is a C₆ cycloaliphatic radical including a methyl group, the methyl group being a functional group, which is an alkyl group. Similarly, the 2-nitrocyclobut-1-yl radical is a C₄ cycloaliphatic radical including a nitro group, the nitro group being a functional group. A cycloaliphatic radical may include one or more halogen atoms, which may be the same or different. Halogen atoms include, for example, fluorine, chlorine, bromine, and iodine. Cycloaliphatic radicals having one or more halogen atoms include 2-trifluoromethylcyclohex-1-yl; 4-bromodifluoromethylcyclooct-1-yl; 2-chlorodifluoromethylcyclohex-1-yl; hexafluoroisopropylidene 2,2-bis(cyclohex-4-yl) (—C₆H₁₀C(CF₃)₂C₆H₁₀—); 2-chloromethylcyclohex-1-yl; or 3-difluoromethylenecyclohex-1-yl. Further examples of cycloaliphatic radicals include 4-allyloxycyclohex-1-yl, 4-aminocyclohex-1-yl (H₂NC₆H₁₀—), 4-amino carbonylcyclopent-1-yl (NH₂COC₅H₈—), 4-acetyloxycyclohex-1-yl, 2,2-dicyanoisopropylidenebis(cyclohex-4-yloxy) (—OC₆H₁₀C(CN)₂C₆H₁₀O—), 3-methylcyclohex-1-yl, methylenebis(cyclohex-4-yloxy) (—OC₆H₁₀CH₂C₆H₁₀O—), 1-ethylcyclobut-1-yl, cyclopropylethenyl, 3-formyl-2-tetrahydrofuranyl, 2-hexyl-5-tetrahydrofuranyl; hexamethylene-1,6-bis(cyclohex-4-yloxy) (—OC₆H₁₀(CH₂)₆C₆H₁₀O—); 4-hydroxymethylcyclohex-1-yl (4-HOCH₂C₆H₁₀—), 4-mercaptomethylcyclohex-1-yl (4-HSCH₂C₆H₁₀—), 4-methylthio cyclohex-1-yl (4-CH₃SC₆H₁₀—), 4-methoxycyclohex-1-yl, 2-methoxy carbonyl cyclohex-1-yloxy (2-CH₃OCOC₆H₁₀O—), 4-nitromethylcyclohex-1-yl (NO₂CH₂C₆H₁₀—), 3-trimethylsilylcyclohex-1-yl, 2-t-butyldimethylsilylcyclopent-1-yl, 4-trimethoxysilylethylcyclohex-1-yl (e.g. (CH₃O)₃SiCH₂CH₂C₆H₁₀—), 4-vinyl cyclohexen-1-yl, vinylidenebis(cyclohexyl), and the like. The term “a C₃-C₃₀ cycloaliphatic radical” includes cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

In one embodiment, a graft copolymer composition is provided. The composition includes a poly alkylene oxide graft copolymer or a poly arylene oxide graft copolymer, the graft copolymer includes a zwitterion. In one embodiment, a composition may include a poly alkylene oxide graft copolymer or a poly arylene oxide graft copolymer. The graft copolymer may include one or both of a polyether or a polyamide.

In one embodiment, the polyalkyleneoxide includes polyethylene oxide. In one embodiment, the polyalkyleneoxide may include a polyethylene oxide-polypropylene oxide block or random copolymer such that the ratio of polyethylene oxide:polypropylene oxide ratio (based on moles of repeating units) is in a range of from about 80 percent to about 40 percent. In one embodiment, the polyarylene oxide is a polyphenylene ether.

Suitable polyarylene ethers or polyarylenes of the invention include those having structures as shown in Formulas 1, 2, and 3. Depending upon the molecular structure, these materials may be produced by one or more of the following methods. These include A) oxidative polymerization of a suitable phenol(s) in the presence of a transition metal catalysts, such as copper or manganese. B) displacement polymerization of a) nucleophilic monomer(s) chosen from the group consisting of a dihydroxyaromatic compound and a dithioaromatic compound with b) a dihaloaromatic compound in the presence of basic catalysis and/or C) displacement polymerization of monomer(s) possessing both electrophilic and nucleophilic groups chosen from the group consisting of hydroxyhaloaromatic monomer(s) or a thiohaloaromatic monomer(s) in the presence of a basic catalyst D) by condensation of dihaloaromatic compounds by reductive coupling with transition metal catalysts, ideally reducing nickel catalysts. Condensation of these monomers in the aforementioned manner leads to the structures of Formulas 1, 2 and 3.

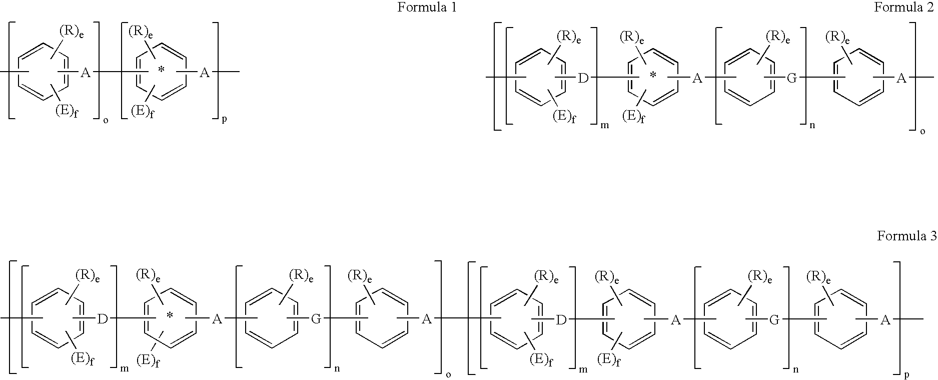

wherein each R is independently a hydrogen, alkyl, aminoalkyl, thioalkyl, hydroxyalkyl, haloalkyl, alkanoyl, acyl, haloalkanoyl, alkoxy, aryl, mixed aliphatic-aromatic hydrocarbon hydroxyl, thiol or amino, or halogen; and E is a monovalent electron withdrawing group selected from the group consisting of sulfonate or its salt, nitrile, formyl, benzoyl, or benzoyl substituted with an aromatic, aliphatic or cycloaliphatic radical, sulfonamide, sulfoxide, sulfone, nitro, aldehyde, trifluoromethyl group; and A is a divalent group selected from the list consisting of oxygen, sulfur or a carbon-carbon single bond; R is a substituent including a member or members selected from an aromatic, aliphatic or cycloaliphatic radical, a polyalkylene ether, zwitterionic or amide group; G includes groups known to link the phenol moieties in known bisphenols and may include a member or members selected from divalent-aromatic, divalent-aliphatic or divalent-cycloaliphatic radicals, a carbon-carbon single bond, polyalkylene ether, zwitterionic or amide group, said groups may be fused to either ring or both. In such cases, the value of e is modified accordingly to satisfy valency of the fused aromatic ring; D is chose from the group consisting of sulfone, carbonyl, phosphonyl including phenylphosphonyl, sufonamide, a carbon-carbon single bond, m and n are from 0-5, ideally 1-2 and o and p may be in a range of from about 1 to about 100, e and f are integers chosen such that for each aromatic ring their sum equals 4.

Certain polyarylene ethers or polyphenylene ethers, such as those given by Formula 1 (wherein A is oxygen), may be produced by oxidative polymerization of suitable phenols having a structure as indicated in Formula 5, where R¹-R⁴ are independently selected from the group consisting of hydrogen, C1-C20 aliphatic, C3-C30 aromatic, C3-C30 cycloaliphatic groups. Suitable R¹-R⁴ may be C1-C12 alkyl, alkenyl, alkynyl, alkoxy, alkenyloxy, alkynyloxy, fluoroalkoxy, chloroalkoxy, thioalkoxy, C6-C18 aryl and C7-C30 mixed alkyl-aryl hydrocarbons or such groups including a member selected from the groups consisting of carboxyalkyl, carboxamide, ketone, aldehyde, alcohol, halogen, nitrile and Q=hydrogen or halogen.

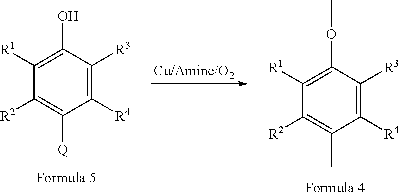

Non-limiting examples of suitable phenols for polymerization into polyphenylene ethers include 2,6-dimethylphenol; 2,6-diphenylphenol; 2,3,6-trimethylphenol; 2-methyl-6-phenylphenol; 2-methyl-6-benzylphenol; 2-methyl-6-styrylphenol; 2-methyl-6-chlorophenol; 2-methyl-6-methoxyphenol; 2-methyl-6-phenoxyphenol; 2-methyl-6-thiomethoxyphenol; 2-methyl-6-ethylphenol; 2-methyl-6-isopropylphenol; and 2-methyl-6-cyclohexylphenol.

Non-limiting examples of suitable polyphenylene ethers include poly(2,6-dimethyl-1,4-phenylene)ether; poly(2,6-diphenyl-1,4-phenylene ether); poly(2,3,6-trimethyl-1,4-phenylene ether); poly(2-methyl-6-phenyl-1,4-phenylene)ether; poly(2-methyl-6-styryl-1,4-phenylene)ether; poly(2-methyl-6-ethyl-1,4-phenylene)ether; poly(2-methyl-6-propyl-1,4-phenylene)ether; poly(2-methyl-6-methoxy-1,4-phenylene)ether; poly(2-methyl-6-ethoxy-1,4-phenylene)ether; poly(2-methoxy-1,4-phenylene)ether poly(2-ethoxy-1,4-phenylene)ether; poly(2-methyl-6-chloro-1,4-phenylene)ether; poly(2-chloro-1,4-phenylene)ether; poly(2-methyl-6-ethyl-1,4-phenylene)ether; poly(2-methyl-6-propyl-1,4-phenylene)ether; poly(2-phenyl-1,4-phenylene)ether; poly(2-benzyl-1,4-phenylene)ether; poly(2-styryl-1,4-phenylene ether); poly(2-methyl-6-ethyl-1,4-phenylene)ether; poly(2-ethyl-n-propyl-1,4-phenylene)ether; poly(2-methyl-6-n-butyl-1,4-phenylene)ether; poly(2-ethyl-6-isopropyl-1,4-phenylene)ether; poly(2-methyl-6-chloro-1,4-phenylene)ether; poly(2-methyl-6-hydroxyethyl-1,4-phenylene)ether; poly(2-methoxy-6-ethoxy-1,4-phenylene ether); poly(2-ethyl-6-propyl-1,4-phenylene ether); poly(2-methyl-6-chloroethyl-1,4-phenylene)ether; poly(2-ethyl-6-acryloyloxy-1,4-phenylene); poly(2-ethyl-6-benzoyloxy-1,4-phenylene)ether; poly(2-ethyl-6-propionyloxy-1,4-phenylene)ether; poly(2-ethyl-6-acetyloxy-1,4-phenylene)ether; poly(2-ethyl-6-stearyloxy-1,4-phenylene)ether; poly(2-methyl-6-chloroethyl-1,4-phenylene)ether; poly(2,3-dimethyl-6-ethyl-1,4-phenylene ether); poly(2-methyl-6-bromomethyl-1,4-phenylene)ether; poly(2-methyl-6-chloromethyl-1,4-phenylene)ether; poly(2-methyl-6-hydroxyethyl-1,4-phenylene)ether; poly(2-methyl-6-n-butyl-1,4-phenylene)ether; poly(2-ethyl-6-isopropyl-1,4-phenylene)ether; poly(2-ethyl-6-n-propyl-1,4-phenylene)ether; poly(2-(4′-methylphenyl)-1,4-phenylene)ether; poly(2-(4′-fluorophenyl)-1,4-phenylene)ether; poly(2-(4′-chlorophenyl)-1,4-phenylene)ether; poly(2-methyl-1,4-phenylene ether); poly(2-chloro-6-ethyl-1,4-phenylene ether); poly(2-chloro-6-bromo-1,4-phenylene ether); poly(2-chloro-6-methyl-1,4-phenylene ether).

Suitable catalyst systems for the preparation of polyphenylene ethers by oxidative coupling include those that contain a heavy metal compound. Suitable heavy metal compounds may include copper, manganese or cobalt. Selection may be based on the desired end-use application.

In one embodiment, the catalyst systems includes of those containing a copper compound. The catalyst may be a combination of cuprous or cupric ions, halide (e.g., chloride, bromide or iodide) ions and an amine. In one embodiment, the catalysts may contain manganese compounds. The catalyst may be alkaline systems in which divalent manganese is combined with such anions as halide, alkoxide or phenoxide. The manganese may be present as a complex with one or more complexing and/or chelating agents such as dialkylamines, alkanolamines, alkylenediamines, o-hydroxyaromatic aldehydes, o-hydroxyazo compounds, hydroxyoximes (monomeric and polymeric), o-hydroxyaryl oximes and diketones. Other suitable catalyst may include cobalt-containing catalyst systems.

In one embodiment, the polyphenylene ethers may contain polymer end groups having a structure as shown by Formulae 6, 7 and 8, where R¹⁻⁴ are as described above and Q=hydrogen or halogen: The structures shown by formulae 6 and 7 are the head and tail end groups expected from head to tail polymerization of monomer; and the structure shown by Formula 8 is produced from incorporation of amine from the catalyst into the polymer chain.

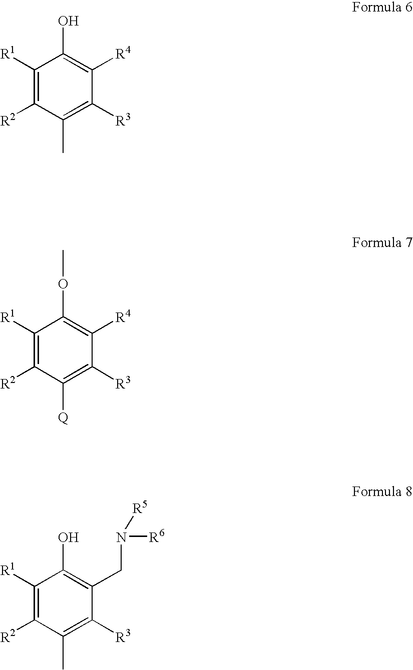

In addition, the polymer chain may contain internal groups as shown by the structures shown in formulae 9, 10, 11 and 12. C₁₋₁₅ alkyl, C₁₋₁₅ chloroalkyl C₁₋₁₅ bromoalkyl C₁₋₁₅ fluoroalkyl, C₆₋₁₈ aryl, C₆₋₁₈ chloroaryl, C₆₋₁₈ bromoaryl, C₆₋₁₈ fluoroaryl C₇₋₂₃ mixed alkyl-aryl hydrocarbons, C₁₋₁₅ alkoxy, C₁₋₁₅ fluoroalkoxy, chloroalkoxy, C₁₋₁₅ thioalkoxy, or such groups including a member or members selected from the groups consisting of carboxyalkyl, carboxamide, ketone, aldehyde, alcohol, halogen, and nitrile.

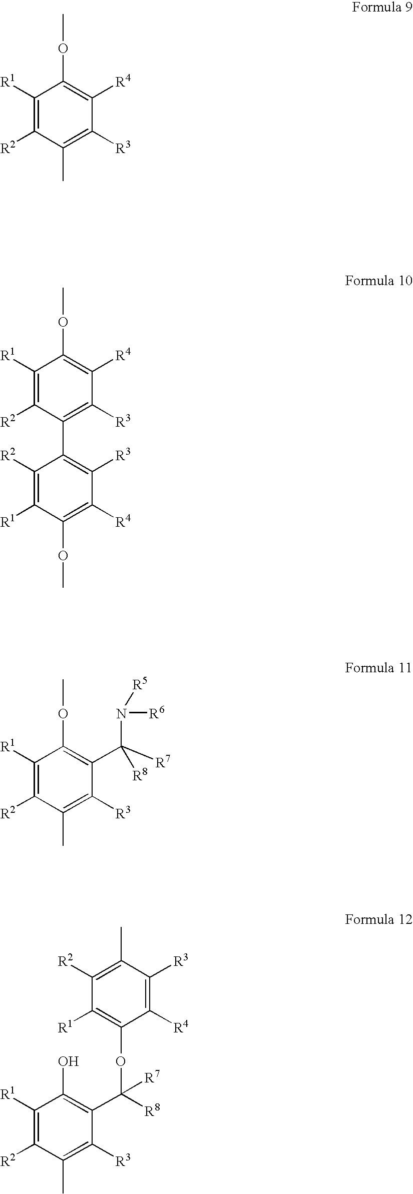

Suitable molecular weights of the polyphenylene ether used to form the graft copolymer composition may be greater than about 1,000 g/mol. In some embodiments, the molecular weight of the polyphenylene ether used to form the graft copolymer composition may be less than about 200,000 g/mol. In one embodiment, the molecular weight of the polymer is in a range of from about 1,000 to about 40,000 g/mol, from about 40,000 to about 80,000 g/mol, from about 80,000 to about 120,000 g/mol, or from about 120,000 g/mol to about 200,000 g/mol. The polymer may have monomodal or polymodal molecular weight distributions and polymers with monomodal or bimodal distributions are useful. In one embodiment, the graft copolymer has a molecular weight distribution about 3. In one embodiment, the graft copolymer has a molecular weight distribution of at least 3. The polymer may be a copolymer of one or more of the aforementioned phenols. The polymer may be a blend of two or more aforementioned polyphenylene ethers. Each polyphenylene ether molecule in the blend may have similar or differing molecular weights, molecular weight distributions, and types and levels of functionality.

Polyarylene ethers may be prepared by displacement polymerization of a) nucleophilic monomer(s) chosen from the group consisting of a dihydroxyaromatic compound and a dithioaromatic compound with b) a dihaloaromatic compound in the presence of a basic catalyst.

Suitable dihaloaromatic compounds include: 2,6-dichlorobenzonitrile; 2,6-difluorobenzonitrile; 2,5-dichlorobenzonitrile; 2,5-difluorobenzonitrile; 2,4-dichlorobenzonitrile; 2,4-difluorobenzonitrile; 4,4′-bis(chlorophenyl)sulfone; 2,4′-bis(chlorophenyl)sulfone; 2,4-bis(chlorophenyl)sulfone; 4,4′-bis(fluorophenyl)sulfone; 2,4′-bis(fluorophenyl)sulfone; 2,4-bis(fluorophenyl)sulfone; 4,4′-bis(chlorophenyl)sulfoxide; 2,4′-bis(chlorophenyl)sulfoxide; 2,4-bis(chlorophenyl)sulfoxide; 4,4′-bis(fluorophenyl)sulfoxide; 2,4′-bis(fluorophenyl)sulfoxide; 2,4-bis(fluorophenyl)sulfoxide; 4,4′-bis(fluorophenyl)ketone; 2,4′-bis(fluorophenyl)ketone; 2,4-bis(fluorophenyl)ketone; 2,6-dichlorobenzaldehyde; 2,6-difluorobenzaldehdye; 2,4-dichlorobenzaldehyde; 2,4-difluorobenzaldehdye; 2,5-dichlorobenzaldehdye; 2,5-difluorobenzaldehdye; 4-(2,6-difluorophenylsulfonyl)dimethylamine; 4-(2,4-difluorophenylsulfonyl)dimethylamine; 4-(2,6-difluorophenylsulfonyl)diethylamine; 4-(2,4-difluorophenylsulfonyl)diethylamine; 4-(2,6-difluorophenylsulfonyl)morpholine; 4-(2,6-difluorophenylsulfonyl)morpholine; 4-(2,4-difluorophenylsulfonyl)morpholine; 4-(2,6-difluorophenylsulfonyl)morpholine; 1,3-bis(4-fluorobenzoyl)benzene; 1,4-bis(4-fluorobenzoyl)benzene; 4,4′-bis(4-chlorophenyl)phenylphosphine oxide; 4,4′-bis(4-fluorophenyl)phenylphosphine oxide; 4,4′-bis(4-fluorophenylsulfonyl)-1,1′-biphenyl, 4,4′-bis(4-chlorophenylsulfonyl)-1,1′-biphenyl, 4,4′-bis(4-fluorophenylsulfoxide)-1,1′-biphenyl, 4,4′-bis(4-chlorophenylsulfoxide)-1,1′-biphenyl, 1,4-bis((4-chlorophenyl)sulfonyl)piperazine; 1,4-bis((4-fluorophenyl)sulfonyl)piperazinebenzenesulfonamide; 3,3′-sulfonylbis(6-chloro-N-((trifluoromethyl)sulfonyl)benzenesulfonamide; 3,3′-sulfonylbis(6-chloro-N,N-dimethyl-4,4′-(sulfonylbis((6-chloro-3,1-phenylene)sulfonyl))bis morpholine. Other suitable dihaloaromatic compounds include methylated derivates of the foregoing.

Suitable dihydroxy aromatic compounds may include one or more of: hydroquinone; resorcinol; 5-cyano-1,3-dihydroxybenzene; 4-cyano-1,3,-dihydroxybenzene; 2-cyano-1,4-dihydroxybenzene; 2-alkoxyhydroquinones, such as 2-methoxyhydroquinone; amides of hydroquinone, such as N,N-dimethyl-3-hydroxysalicylamide; 2,2′-biphenol; 4,4′-biphenol; 2,2′-dimethylbiphenol 2,2′,6,6′-tetramethylbiphenol; 2,2′,3,3′,6,6′-hexamethylbiphenol; 3,3′,5,5′-tetrabromo-2,2′6,6′-tetramethylbiphenol; 4,4′-isopropylidenediphenol (bisphenol A); 4,4′-isopropylidenebis(2,6-dimethylphenol) (tetramethyl bisphenol A); 4,4′-isopropylidenebis(2-methylphenol); 4,4′-isopropylidenebis(2-allylphenol); 4,4′-isopropylidenebis(2-allyl-6-methylphenol); 4,4′-(1,3-phenylenediisopropylidene)bisphenol (bisphenol M); 4,4′-isopropylidenebis(3-phenylphenol); 4,4′-isopropylidenebis(2-phenylphenol); 4,4′-(1,4-phenylenediisopropylidene)bisphenol (bisphenol P); 4,4′-ethylidenediphenol (bisphenol E); 4,4′-oxydiphenol; 4,4′-thiodiphenol; 4,4′-thiobis(2,6-dimethylphenol); 4,4′-sulfonyldiphenol; 4,4′-sulfonylbis(2,6-dimethylphenol) 4,4′-sulfinyldiphenol; 4,4′-hexafluoroisopropylidenebisphenol (Bisphenol AF); 4,4′-hexafluoroisopropylidene)bis(2,6-dimethylphenol); 4,4′-(1-phenylethylidene)bisphenol (Bisphenol AP); 4,4′-(1-phenylethylidene)bis(2,6-dimethylphenol); bis(4-hydroxyphenyl)-2,2-dichloroethylene (Bisphenol C); bis(4-hydroxyphenyl)methane (Bisphenol-F); bis(2,6-dimethyl-4-hydroxyphenyl)methane; 2,2-bis(4-hydroxyphenyl)butane; 3,3-bis(4-hydroxyphenyl)pentane; 4,4′-(cyclopentylidene)diphenol; 4,4′-(cyclohexylidene)diphenol (Bisphenol Z); 4,4′-(cyclohexylidene)bis(2-methylphenol); 4,4′-(cyclododecylidene)diphenol; 4,4′-(bicyclo(2.2.1)heptylidene)diphenol; 4,4′-(9H -fluorene-9,9-diyl)diphenol; 4,4′-(9H-fluorene-9,9-diyl)bis(2,6-dimethylphenol); 4,4-bis(4-hydroxyphenyl)pentanoic acid; 4,4-bis(4-hydroxy-3,5-dimethylphenyl)pentanoic acid; diphenolic acid and amide derivatives thereof; 4,4-bis(4-hydroxy-3-methylphenyl)pentanoic acid; 3,3′-bis(4-hydroxyphenyl)isobenzofuran-1(3H)-one; 1-(4-hydroxyphenyl)-3,3′-dimethyl-2,3-dihydro-1H-inden-5-ol; 1-(4-hydroxy-3,5-dimethylphenyl)-1,3,3′,4,6-pentamethyl-2,3-dihydro-1H-inden-5-ol; 3,3,3′,3′-tetramethyl-2,2′,3,3′-tetrahydro-1,1′-spirobi(indene)-5,6′-diol (Spirobiindane); dihydroxybenzophenone (bisphenol K); thiodiphenol (Bisphenol S); bis(4-hydroxyphenyl)diphenylmethane; bis(4-hydroxyphenoxy)-4,4′-biphenyl; and 4,4′-bis(4-hydroxyphenyl)diphenyl ether.

Other suitable multihydroxyl aromatics may include, for example, 9,9-bis(3-methyl-4-hydroxyphenyl)fluorene; 3,3-bis(4-hydroxyphenyl)phthalimide, such as N-phenyl-3,3-bis(4-hydroxyphenyl)phthalimide; N-amino-3,3-bis(4-hydroxyphenyl)phthalimide; N-hydroxy-3,3-bis(4-hydroxyphenyl)phthalimide; N-alkoxyethyl-3,3-bis(4-hydroxyphenyl)phthalimide; N-acylamido-3,3-bis(4-hydroxyphenyl)phthalimide; N-acyloxy-3,3-bis(4-hydroxyphenyl)phthalimide. Still other suitable materials may include such derivatives substituted or unsubstituted aliphatic or aromatic radicals, 4,4-bis(4-hydroxyphenyl)butanoic acid; 4,4-bis(4-hydroxyphenyl)pentanoic acid; 4,4-bis(4-hydroxyphenyl)butanoamide; 4,4-bis(4-hydroxyphenyl)pentanoamide; 4,4-bis(4-hydroxyphenyl)butanonitrile; 4,4-bis(4-hydroxyphenyl)pentanonitrile and aromatic ring methylated derivatives of the foregoing.

In one embodiment, the aromatic dihydroxy compound may include a sulfone. Suitable sulfones may include, for example, 4,4′-dihydroxyphenyl sulfone; 2,4′-dihydroxyphenyl sulfone; 3,3′-dihydroxydiphenyl sulfone; 2,2′-dihydroxydiphenyl sulfone; bis(3,5-dimethyl-4-hydroxyphenyl)sulfone. In one embodiment, the sulfone may be 4,4′-dihydroxydiphenyl sulfone or an aromatic ring methylated derivatives thereof.

Still other suitable aromatic dihydroxy compounds may include a nitrile group. Such nitrile-containing compounds may include 1-cyano-3,5-dihydroxy benzene; 1-cyano-2,4-dihydroxy benzene; 1,2-dicyano-3,6-dihydroxy benzene; 4,4-bis(4-hydroxyphenyl)propanonitrile; and 4,4-bis(4-hydroxyphenyl)butanonitrile. In one embodiment, the suitable nitrile-containing aromatic dihydroxy compounds may include methylated derivatives of the foregoing.

The list of suitable aromatic dihydroxy compounds further includes amide-containing aromatic dihydroxy compound. Suitable amide-containing aromatic dihydroxy compound may include 4,4-bis(4-hydroxyphenyl)butanoamide; 4,4-bis(4-hydroxyphenyl)pentanoamide; (4,4-bis(4-hydroxyphenyl)-1-oxopentyl)methoxypoly(oxy-1,2-ethanediyl); dimethyl gentisamide; 3,3-bis(4-hydroxyphenyl)phthalimides; and N-(3,3-bis(4-hydroxyphenyl)phthalimide methoxypoly(oxy-1,2-ethanediyl). In one embodiment, the suitable amide-containing aromatic dihydroxy compounds may include methylated derivatives of the foregoing.

Still other suitable aromatic dihydroxy compounds may include a carboxylic acid or ester moiety. Such bisphenol structures may include 4,4-bis(4-hydroxyphenyl)butanoic acid; 4,4-bis(4-hydroxyphenyl)pentanoic acid; t-butyl 4,4-bis(4-hydroxyphenyl)butanoate; 1,2-dihydroxy propane-4,4-bis(4-hydroxyphenyl)butanoate; and (4,4-bis(4-hydroxyphenyl)-1-oxopentyl)methoxypoly(oxy-1,2-ethanediyl). In one embodiment, the suitable carboxylic acid or ester-containing aromatic dihydroxy compounds may include methylated derivatives of the foregoing.

Within the composition may be a polyarylether that may be a homopolymer, a random copolymer, a block copolymer, or a graft copolymer. Copolymers are polymers that comprise structural units derived from more than one monomer. Block copolymers comprise structural units derived from at least two different monomers, wherein the structural units from each monomer form blocks of chains linked in substantially linear fashion. Alternating copolymers comprise structural units derived from two monomers, and the structural units from each of the two monomers are substantially alternating along the length of the polymer chain. Graft copolymers comprise structural units derived from at least two monomers, wherein the structural units derived from one monomer form part of the main chain, and structural units derived from the other monomers form part of the side chain.

An alkali metal compound may be used to effect the reaction between the dihalobenzonitriles and aromatic dihydroxy compounds, and is not particularly limited so far as it can convert the aromatic dihydroxy compound to the corresponding alkali metal salt. Exemplary alkali metal compounds include alkali metal hydroxides, such as lithium hydroxide, sodium hydroxide, potassium hydroxide, rubidium hydroxide, and cesium hydroxide; alkali metal carbonates, such as, but not limited to, lithium carbonate, sodium carbonate, potassium carbonate, rubidium carbonate, and cesium carbonate; and alkali metal hydrogen carbonates, such as but not limited to lithium hydrogen carbonate, sodium hydrogen carbonate, potassium hydrogen carbonate, rubidium hydrogen carbonate, and cesium hydrogen carbonate.

Some examples of the aprotic polar solvent that may be used to make the polyarylether include N,N-dimethylformamide; N,N-diethylformamide; N,N-dimethylacetamide; N,N-diethylacetamide; N,N-dipropylacetamide; N,N-dimethylbenzamide; N-methyl-2-pyrrolidinone (NMP); N-ethyl-2-pyrrolidinone; N-isopropyl-2-pyrrolidinone; N-isobutyl-2-pyrrolidinone; N-n-propyl-2-pyrrolidinone; N-n-butyl-2-pyrrolidone; N-cyclohexyl-2-pyrrolidinone; N-methyl-3-methyl-2-pyrrolidinone; N-ethyl-3-methyl-pyrrolidinone; N-methyl-3,4,5-trimethyl-2-pyrrolidinone; N-methyl-2-piperidinone; N-ethyl-2-piperidinone; N-isopropyl-2-piperidinone; N-methyl-6-methyl-2-piperidinone; N-methyl-3-ethylpiperidinone; dimethylsulfoxide (DMSO); diethylsulfoxide; sulfolane; N,N′-dimethylimidazolidinone (DMI); diphenylsulfone; and combinations of two or more thereof.

The reaction may be conducted at a temperature greater than about 100 degrees Celsius. Other suitable reactions may be conducted at a temperature that is less than about 300 degrees Celsius. In one embodiment, the reaction temperature is in a range of from about from 100 degrees Celsius to about 120 degrees Celsius, from about from 120 degrees Celsius to about 140 degrees Celsius, from about from 140 degrees Celsius to about 160 degrees Celsius, from about from 160 degrees Celsius to about 180 degrees Celsius, from about from 180 degrees Celsius to about 200 degrees Celsius, from about from 200 degrees Celsius to about 250 degrees Celsius, from about from 250 degrees Celsius to about 290 degrees Celsius, or greater than 290 degrees Celsius. The reaction mixture can be dried by addition of a solvent that forms an azeotrope with water, in addition to the already present polar aprotic solvent. After removal of adventitious water by azeotropic drying the reaction can be carried out at an elevated temperature between 150 degrees Celsius and 300 degrees Celsius. The reaction can be conducted for a time period in a range of from about 1 hour to about 72 hours.

Alternatively, bisphenol can be converted to its dimetallic salt and can be isolated and dried. The anhydrous dimetallic salt can be used directly in the condensation polymerization reaction with a dihaloaromatic compound in a solvent. That solvent can be a halogenated aromatic or a polar aprotic solvent. The polymerization reaction proceeds at a temperature in a range of from about 120 to about 300 degrees Celsius.

When halogenated aromatic solvents are used, a phase transfer catalyst may be a reaction aide. Suitable phase transfer catalysts include hexaalkylguanidinium salts and bis-guanidinium salts. The phase transfer catalyst may include an anionic species such as halide, mesylate, tosylate, tetrafluoroborate, or acetate as a charge-balancing counterion(s). Other suitable phase transfer catalysts may include p-dialkylaminopyridinium salts, bis-dialkylaminopyridinium salts, bis-quaternary ammonium salts, bis-quaternary phosphonium salts, and phosphazenium salts.

After completing the polymerization reaction, the polymer may be separated from the inorganic salts precipitated into a nonsolvent and collected by filtration and drying, under vacuum and/or at high temperature.

The glass transition temperature (T_{g}) of the polymer may be greater than about 100 degrees Celsius. In one embodiment, the glass transition temperature is in a range of from about 100 degrees Celsius to about 110 degrees Celsius, from about 110 degrees Celsius to about 120 degrees Celsius, from about 120 degrees Celsius to about 130 degrees Celsius, from about 130 degrees Celsius to about 140 degrees Celsius, from about 140 degrees Celsius to about 150 degrees Celsius, from about 150 degrees Celsius to about 160 degrees Celsius, from about 160 degrees Celsius to about 170 degrees Celsius, from about 170 degrees Celsius to about 180 degrees Celsius, from about 180 degrees Celsius to about 190 degrees Celsius, or greater than about 190 degrees Celsius.

Polyarylenes include those prepared by condensation of dihaloaromatic compounds by reductive coupling with transition metal catalysts. In one embodiment the polyarylenes include those soluble in polar aprotic solvents, such as N-methylpyrrolidinone, N,N-dimethyl acetamide. In another embodiment, polyarylenes having pendant benzoyl or substituted benzoyl side groups are included, such as poly-1,4-(benzoylphenylene).

Another embodiment of this invention includes functional graft polymers including functional graft copolymers and a method for their preparation. A functional graft polymer is a polymer of Formulas 1-3 wherein R is selected from the group consisting of aminoalkyl, thioalkyl, hydroxyalkyl, haloalkyl, alkanoyl, acyl, haloalkanoyl, hydroxyl, thiol or amino. In another embodiment, where a portion of the repeat units are so functionalized, the polymer is referred to as a functional graft copolymer. These compositions may be prepared by methods known to one of ordinary skill in the art.

For example functional graft polymers may be prepared by reacting monomers with a member or members selected from the group consisting of aminoalkyl, thioalkyl, hydroxyalkyl, haloalkyl, alkanoyl, acyl, haloalkanoyl, hydroxyl, thiol or amino or a protected version thereof.

In one embodiment haloalkyl comprising functional graft copolymers are prepared by conversion of the alkyl or acyl group containing polymers of Formulas 1-3 (R=alkyl or acyl) to haloalkylated, (such as a halomethylated), or a haloacylated (such as an a-bromoacetylated) derivatives of Formulas 1-3 (R=haloalkyl or haloacyl) wherein halogen is I, Br or Cl. Such conversion may be performed using a corresponding halogenating agent such as a molecular halogen (I2, Br2, Cl2) or a haloacetamide or a halosuccinimide. The resulting halomethylated derivatives may be converted to the desired functionalized polyarylether by displacing the halogen with an oxygen or nitrogen of a member or member selected from the group consisting of select group of amines, amides, polyalkylene oxides, amino acids, peptides, saccharides or zwitterionic compounds.

In another embodiment, functional graft copolymers may be prepared from haloacylated or halomethylated polymer by treatment with an excess of amino compound, such as an alkyl or dialkylamine, such as ethylamine, dimethylamine or piperazine or morpholine, to produce an aminated functional graft copolymer. The resulting amino alkylated derivatives may be converted to the desired functionalized polyarylether by reacting with a member or members selected from the group consisting of select group of amides, polyalkylene oxides, amino acids, peptides, saccharides or zwitterionic compounds containing a displaceable halogen. Alternatively they may be prepared by reaction of an amine containing polyether with a cyclic ester or anhydride such as sulfolane, or a 1,3-dioxaphospholane.

In one embodiment, the R or G groups of the polyarylene ethers or polyarylenes of the Formulas 1, 2 or 3 contain a polyalkylene ether or a polyethylenimine. Polyalkylene ethers include those given by Formula 14. Each R is independently a hydrogen, aromatic or aliphatic radical; A is oxygen or sulfur; and q and s are each numbers in a range of from 0 to about 100. The polymer may be linear, branched or dendritic. The polymer may have a molecular weight of greater than about 50. In one embodiment, the molecular weight is in a range of from about 50 to 1000, from about 1000 to about 2000, or greater than about 2000. Some suitable polyethyleneimines are shown by Formula 13 where A is an NH group; and q and s are numbers from 0 to about 300. The NH group of Formula 13 may be alkylated with other groups of Formula 13 to produce branched or dendritic structures. These polymers either may be linear, branched or dendritic or have molecular weights of greater than about 50.

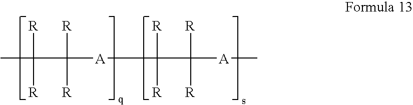

The graft copolymer polyarylene ethers or polyarylenes can include a zwitterion. A zwitterion is an electrically neutral compound that carries formal positive and negative charges on different atoms. Suitable zwitterions may include a phosphorus, sulfur or nitrogen atom. Other suitable zwitterions may be an alkaloid or an amino acid. Suitable amino acids may include glycine or alanine. Yet another suitable zwitterion can include lysergic acid, or a derivative thereof. In one embodiment, a suitable zwitterion is derived from 4-(2-hydroxyethyl)-1-piperazine ethane sulfonic acid; piperazine-N,N′-bis(2-ethanesulfonic acid); 3-(N-morpholino)propane sulfonic acid; or ((cholamido propyl)dimethyl ammonio)-1-propane sulfonate.

In one embodiment, in the polyarylene ether or polyarylene of the structure shown in formulas 1, 2 or 3 R or G includes a composition containing a structure represented by at least one of Formulas 14, 15 or 16.

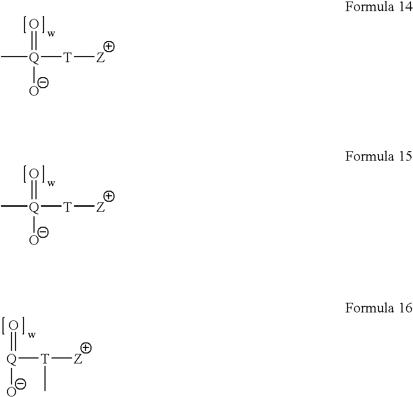

wherein Q is sulfur, carbon, or phosphorus; w is 1 or 2 depending upon the valency of Q, T is selected from C1-C20 aliphatic, C3-C30 aromatic, C3-C30 cycloaliphatic radicals, and Z is selected from the group consisting of ammonium, phosphonium, and sulfonium ion containing groups.

Other suitable zwitterions for use in embodiments of the invention are shown in Table 1. Reference terms “m” and “n” are integers in the case of single molecules, or fractional numbers in the case of averages across multiple molecules. In Table 1, the terms “m” and “n” are independently from each other a value in a range of from 1 to about 100.

The zwitterionic portion of the functional group-containing polyarylene ether may be greater than about 1 weight percent of the total weight of the polymer. In one embodiment, the amount present may be in a range of from about 1 weight percent to about 25 weight percent, from about 25 weight percent to about 50 weight percent from about 50 weight percent to about 75 weight percent, or from about 75 weight percent to about 90 weight percent of total weight of the graft copolymer composition. Alternatively, rather than a zwitterionic portion, the graft copolymer may include one or more of an polyethyleneimine portion, amide portion, or polyamide portion.

TABLE 1
Exemplary zwitterion structures.

| | |
|---|---|
| 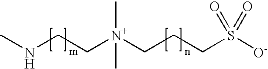 | 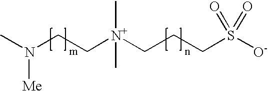 |
| 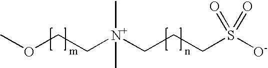 | 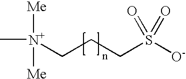 |
| 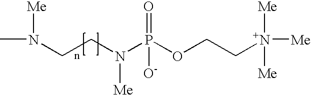 | 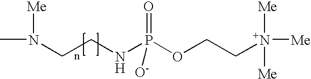 |
| 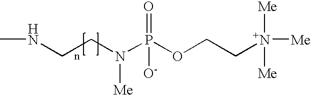 | 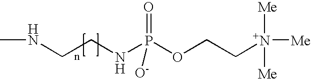 |
| 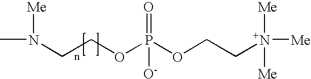 | 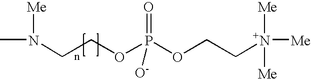 |
| 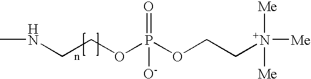 | 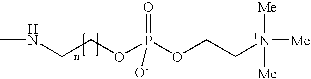 |
| 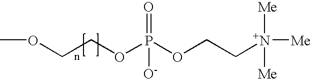 | 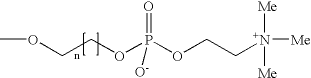 |

In one embodiment, the R or G groups of the polyarylene ethers or polyarylenes of the Formulas 1, 2 or 3 contain an amide or polyamide. Suitable polyamides include those of Formulas 17 and 18.

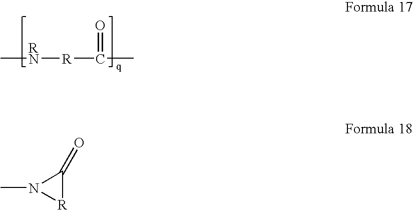

where each R is independently a C1-C100 divalent aliphatic radical, in another embodiment a C1-C10 divalent aromatic or aliphatic radical, and in still another embodiment a C1-C4 aromatic or aliphatic radical.

The graft polymer or copolymer composition may include a filler. Suitable fillers may include silica, alumina, manganese compounds. The filler is added in an amount such that the balance combination of the mechanical properties is not affected. The filler may be selected from the group consisting of calcium carbonate, mica, kaolin, talc, carbon nanotubes, magnesium carbonate, sulfates of barium, calcium sulfate, titanium, nano clay, carbon black, silica, hydroxides of aluminum or ammonium or magnesium, zirconia, nanoscale titania, or two or more thereof. In one embodiment, the filler may be silver. In one embodiment, the silver may be nano silver.

One useful class of fillers is the particulate fillers, which may be of any configuration, for example, spheres, plates, fibers, acicular, flakes, whiskers, or irregular shapes. Suitable fillers have an average longest dimension in a range of from about 1 nanometer to about 500 micrometers. The average aspect ratio (length:diameter) of some fibrous, acicular, or whisker-shaped fillers (e.g., glass or wollastonite) may be greater than 1.5. In one embodiment, average aspect ratio may be less than about 1000. The mean aspect ratio (mean diameter of a circle of the same area:mean thickness) of plate-like fillers (e.g., mica, talc, or kaolin) may be greater than about 5. Bimodal, trimodal, or higher mixtures of aspect ratios may be used.

The fillers may be of natural or synthetic, mineral or non-mineral origin, provided that the fillers have sufficient thermal resistance to maintain their solid physical structure at least at the processing temperature of the composition with which it is combined. Suitable fillers include clays, nanoclays, carbon black, wood flour either with or without oil, various forms of silica (precipitated or hydrated, fumed or pyrogenic, vitreous, fused or colloidal, including common sand), glass, metals, inorganic oxides (such as oxides of the metals in Periods 2, 3, 4, 5 and 6 of Groups Ib, IIb, IIIa, IIIb, IVa, IVb (except carbon), Va, VIa, VIIa and VIII of the Periodic Table), oxides of metals (such as aluminum oxide, titanium oxide, zirconium oxide, titanium dioxide, nanoscale titanium oxide, aluminum trihydrate, vanadium oxide, antimony trioxide and magnesium oxide), hydroxides of aluminum or ammonium or magnesium, carbonates of alkali and alkaline earth metals (such as calcium carbonate, barium carbonate, and magnesium carbonate), silicates (such as aluminosilicates, calcium silicate, zirconium silicates), diatomaceous earth, fuller earth, kieselguhr, mica, talc, slate flour, volcanic ash, cotton flock, asbestos, kaolin, alkali and alkaline earth metal sulfates (such as sulfates of barium and calcium sulfate), titanium, zeolites, wollastonite, titanium boride, zinc borate, silicon carbide, tungsten carbide, ferrites, molybdenum disulfide, asbestos, cristobalite, and combinations.

The filler may be a reinforcing fabric for a composite membrane. The fabric may be a monofilament or multifilament fiber. Suitable materials for use as reinforcing fabric may include one or more polyester, polyimide, polyphenylene, polyphenylene sulfide, polytetrafluoroethylene, or polyetherimide. Fibrous fillers may be supplied in the form of, for example, woven fibrous reinforcements, 0-90 degree fabrics or the like; non-woven fibrous reinforcements such as continuous strand mat, chopped strand mat, papers and felts or the like; or three-dimensional reinforcements such as braids.

Optionally, the fillers may be surface modified, for example treated so as to improve the compatibility of the filler and the polymeric portions of the compositions, which facilitates deagglomeration and the uniform distribution of fillers into the polymers. One suitable surface modification is the durable attachment of a coupling agent that subsequently bonds to the polymers. Use of suitable coupling agents may also improve ductility, tensile, flexural, and/or selectivity and flux performance of membranes, dielectric properties in plastics and elastomers; film integrity, substrate adhesion, weathering and service life in coatings; and application and tooling properties, substrate adhesion, cohesive strength, and service life in adhesives and sealants. Suitable coupling agents include silanes, titanates, zirconates, zircoaluminates, carboxylated polyolefins, organosilicon compounds, and reactive cellulosics. The fillers may be partially or entirely coated with a layer of metallic material e.g., gold, copper, silver, and the like. The metallic coating may enhance antimicrobial activity and be Raman active.

The claimed composition may contain one or more additives. The additives may be selected to affect the characteristics and properties of an article made from the composition. Mixtures of additives may be used. Such additives may be mixed at a suitable time during the mixing of the components for forming the composition. If present, the additive may be in a range of from about 0.1 weight percent to about 20 weight percent, based on the total weight of composition.

Alternatively, the thermoplastic composition may be essentially free of chlorine and bromine. Essentially free of chlorine and bromine as used herein refers to materials produced without the intentional addition of chlorine or bromine or chlorine or bromine containing materials. It is understood however that in facilities that process multiple products a certain amount of cross contamination may occur resulting in bromine and/or chlorine levels may be on the parts per million by weight scale. With this understanding it may be readily appreciated that essentially free of bromine and chlorine may be defined as having a bromine and/or chlorine content of less than about 100 parts per million by weight (ppm), less than about 75 ppm, or less than about 50 ppm. When this definition is applied to the fire retardant it is based on the total weight of the fire retardant. When this definition is applied to the thermoplastic composition it is based on the total weight of the polymer portion of the composition and fire retardant.

Neutralizing additives may be for example, melamine, polyvinylpyrrolidone, dicyandiamide, triallyl cyanurate, urea derivatives, hydrazine derivatives, amines, polyamides, and polyurethanes; alkali metal salts and alkaline earth metal salts of higher fatty acids, such as for example, calcium stearate, calcium stearoyl lactate, calcium lactate, zinc stearate, magnesium stearate, sodium ricinoleate, and potassium palmitate; antimony pyrocatecholate, zinc pyrocatecholate, and hydrotalcites and synthetic hydrotalcites. Hydroxy carbonates, magnesium zinc hydroxycarbonates, magnesium aluminum hydroxycarbonates, and aluminum zinc hydroxycarbonates; as well as metal oxides, such as zinc oxide, magnesium oxide and calcium oxide; peroxide scavengers, such as, e.g., (C10-C20) alkyl esters of beta-thiodipropionic acid, such as for example the lauryl, stearyl, myristyl or tridecyl esters; mercapto benzimidazole or the zinc salt of 2-mercaptobenzimidazole, zinc-dibutyldithiocarbamate, dioctadecyldisulfide, and pentaerythritol tetrakis(.beta.-dodecylmercapto)propionate may be used. When present, the neutralizers may be used in an amount in a range of from about 0.1 to about 20 parts by weight, and from about 20 to about 50 parts by weight, based on 100 parts by weight of the polymer portion of the composition.

In one embodiment, the optional additive is a polyamide stabilizer, such as, copper salts in combination with iodides and/or phosphorus compounds and salts of divalent manganese. Examples of sterically hindered amines include, but are not restricted to, triisopropanol amine or the reaction product of 2,4-dichloro-6-(4-morpholinyl)-1,3,5-triazine with a polymer of 1,6-diamine, N,N′-Bis(-2,2,4,6-tetramethyl-4-piperidinyl)hexane.

Other suitable additives may include antioxidants, and UV absorbers, and other stabilizers. Antioxidants include i) alkylated monophenols, for example: 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(alpha-methylcyclohexyl)-4,6 dimethylphenol, 2,6-di-octadecyl-4-methylphenol, 2,4,6,-tricyclohexylphenol, 2,6-di-tert-butyl-4-methoxymethylphenol; ii) alkylated hydroquinones, for example, 2,6-di-tert-butyl-4-methoxyphenol, 2,5-di-tert-butyl-hydroquinone, 2,5-di-tert-amyl-hydroquinone, 2,6-diphenyl-4octadecyloxyphenol; iii) hydroxylated thiodiphenyl ethers; iv) alkylidene-bisphenols; v) benzyl compounds, for example, 1,3,5-tris-(3,5-di-tert-butyl-4-hydroxybenzyl)-2,4,6-trimethylbenzene; vi) acylaminophenols, for example, 4-hydroxy-lauric acid anilide; vii) esters of beta-(3,5-di-tert-butyl-4-hydroxyphenol)-propionic acid with monohydric or polyhydric alcohols; viii) esters of beta-(5-tert-butyl-4-hydroxy-3-methylphenyl)-propionic acid with monohydric or polyhydric alcohols; vii) esters of beta-(5-tert-butyl-4-hydroxy-3-methylphenyl)propionic acid with mono- or polyhydric alcohols, e.g., with methanol, diethylene glycol, octadecanol, triethylene glycol, 1,6-hexanediol, pentaerythritol, neopentyl glycol, tris(hydroxyethyl)isocyanurate, thiodiethylene glycol, N,N-bis(hydroxyethyl)oxalic acid diamide.

Suitable UV absorbers and light stabilizers may include i) 2-(2′-hydroxyphenyl)-benzotriazoles, for example, the 5′methyl-, 3′5′-di-tert-butyl-, 5′-tert-butyl-, 5′(1,1,3,3-tetramethylbutyl)-, 5-chloro-3′,5′-di-tert-butyl-, 5-chloro-3′tert-butyl-5′methyl-, 3′sec-butyl-5′tert-butyl-, 4′-octoxy, 3′,5′-ditert-amyl-3′,5′-bis-(alpha, alpha-dimethylbenzyl)-derivatives; ii) 2-Hydroxy-benzophenones, for example, the 4-hydroxy-4-methoxy-4-octoxy, 4-decyloxy-, 4-dodecyloxy-, 4-benzyloxy, 4,2′,4′-trihydroxy- and 2′-hydroxy-4,4′-dimethoxy derivative, and iii) esters of substituted and unsubstituted benzoic acids for example, phenyl salicylate, 4-tert-butylphenyl-salicylate, octylphenyl salicylate, dibenzoylresorcinol, bis(4-tert-butylbenzoyl)resorcinol, benzoylresorcinol, 2,4-di-tert-butyl-phenyl-3,5-di-tert-butyl-4-hydroxybenzoate and hexadecyl-3,5-di-tert-butyl-4-hydroxybenzoate.

Other suitable additives may include plasticizers, lubricants, and/or mold release agents. These additives may include one or more of phthalic acid esters; tris(octoxycarbonylethyl)isocyanurate; tristearin; di- or polyfunctional aromatic phosphates such as resorcinol tetraphenyl diphosphate (RDP), the bis(diphenyl)phosphate of hydroquinone and the bis(diphenyl)phosphate of bisphenol-A; poly-alpha-olefins; epoxidized soybean oil; silicones, including silicone oils; sodium, calcium or magnesium salts of fatty acids such as lauric acid, palmitic acid, oleic acid or stearic acid; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants including polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax, EBS wax, or the like. Such materials may be used in amounts in a range of from about 0.1 parts by weight to about 20 parts by weight, based on 100 parts by weight of the polymer portion of the composition.

Other additives may include polymeric agents. Suitable agents may include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations including. Other suitable polymeric agents may include certain polyesteramides polyether-polyamide (polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric agents are commercially available, for example PELESTAT 6321 (Sanyo) or PEBAX MH1657 (Atofina), IRGASTAT P18 and P22 (Ciba-Geigy). Other polymeric materials include inherently conducting polymers such as polyaniline (commercially available as PANIPOL®EB from Panipol), polypyrrole and polythiophene (commercially available from Bayer), which retain some of their intrinsic conductivity after processing. In one embodiment, carbon fibers, carbon nanofibers, carbon nanotubes, carbon black, or a combination of the foregoing may be used in a polymeric resin containing chemical antistatic agents to render the composition electrostatically dissipative. The agents may be present in an amount in a range of from about 0.05 parts by weight to about 20 parts by weight, based on 100 parts by weight of the polymer portion of the composition.

In one embodiment, the polyarylene ether or polyarylene is soluble in polar aprotic solvent. Non-limiting examples of the solvents include dimethylsulfoxide, N,N-dimethylacetamide, sulfolane N-methylpyrrolidinone, N,N-dimethylformamide,

The polyarylene ether or polyarylene graft copolymer may have a glass transition temperature of at least 100 degrees Celsius. In one embodiment, the graft copolymer has a glass transition temperature in the range of from about 100 degrees Celsius to about 150 degrees Celsius, from about 150 degrees Celsius to about 160 degrees Celsius, from about 160 degrees Celsius to about 170 degrees Celsius, from about 170 degrees Celsius to about 180 degrees Celsius, from about 180 degrees Celsius to about 200 degrees Celsius, from about 200 degrees Celsius to about 210 degrees Celsius, from about 210 degrees Celsius to about 230 degrees Celsius, or greater than about 230 degrees Celsius.

Wetting is the contact, or lack of contact, between a fluid and solid surface when the two are brought into contact. A liquid with a high surface energy will form a spherical droplet, while a low surface energy liquid will form a plate that spreads out over the surface—the surface energy of the drop is taken relative to the surface energy of the solid surface. Unless specified herein, the reference fluid will be pure water at room temperature, thus leaving the variable to be the solid having the surface. A measurement method to determine wettability and/or the degree of hydrophilicity is a contact angle measurement. This measures the angle between the surface of the solid and the surface of the liquid droplet. A more hydrophobic surface would have a higher contact angle than a hydrophilic surface, for the same fluid and conditions. Hydrophilic is defined as a surface with a contact angle of less than 90 degrees of a pure water droplet at room temperature. The lower the contact angle, then the lower the surface energy of the solid and the greater the hydrophilicity. As noted herein, the greater the hydrophilicity, then the more likely the solid surface has biocompatibility and hemocompatibility characteristics in a useful range.

The polyarylene ether or polyarylene has a contact angle that is less than about 85 degrees. In one embodiment, the contact angle is in a range of from about 85 degrees to about 55 degrees, from about 55 degrees to about 45 degrees, from about 45 degrees to about 40 degrees, from about 40 degrees to about 35 degrees, from about 35 degrees to about 30 degrees or less, as measured using the sessile drop method. The sessile drop method is an optical contact angle measurement method. Another suitable test method for contact angle giving about the same results involves a goniometer such as is commercially available from Rame-hart Instrument Co. (Netcong, N.J.).

The graft copolymer in one embodiment may be dendritic. In one embodiment, the graft copolymer may be linear. In one embodiment, the graft copolymer may be a comb. In one embodiment, the graft copolymer has blocks of AB, ABA, BAB, where A may be the polyarylene oxide or alkylene oxide and B is the zwitterion.

A method for making a polyarylene ether composition in accordance with one embodiment includes contacting a reactive polyarylene ether composition with a polyalkylene oxide or a polyarylene oxide to a zwitterion such that the zwitterion secures to a surface of the graft copolymer. The surface treated graft copolymer composition may be contacted with a filler to form a filled composition. Contacting may include mixing or blending. The mixing or blending can be performed in solid-form, melt form, or by solution mixing.

Solid-blending or melt-blending of the filler and the graft composition may involve the use of one or more of shear force, extensional force, compressive force, ultrasonic energy, electromagnetic energy, or thermal energy. Blending may be conducted in a processing equipment wherein the aforementioned forces may be exerted by one or more of single screw, multiple screws, intermeshing co-rotating or counter rotating screws, non-intermeshing co-rotating or counter rotating screws, reciprocating screws, screws with pins, barrels with pins, rolls, rams, or helical rotors. The materials may by hand mixed but also may be mixed by mixing equipment such as dough mixers, chain may mixers, planetary mixers, twin screw extruder, two or three roll mill, BUSS kneader, HENSCHEL, helicones, ROSS mixer, BANBURY, roll mills, molding machines such as injection molding machines, vacuum forming machines, blow molding machine, or the like. Blending may be performed in batch, continuous, or semi-continuous mode. With a batch mode reaction, for instance, all of the reactant components may be combined and reacted until most of the reactants may be consumed. The reaction may be stopped and additional reactant added. With continuous conditions, the reaction does not have to be stopped in order to add more reactants. Solution blending may also use additional energy such as shear, compression, ultrasonic vibration, or the like to promote homogenization of the filler in the underfill composition. A filled or an unfilled composition may be contacted with a cure catalyst prior to blending or after blending.

The mixture may be solution blended by sonication for a time period effective to disperse the filler particles within the polymer precursor. In one embodiment, the fluid may swell the polymer precursor during the process of sonication. Swelling of the polymer may improve the ability of the filler to impregnate the polymer precursor during the solution blending process and consequently improve dispersion.

In some embodiments solvents may be used in the solution blending of the graft copolymer composition. A solvent may be used as a viscosity modifier, or to facilitate the dispersion and/or suspension of the filler composition. Suitable liquid aprotic polar solvents may include sulfolane, dimethylformamide, and N-methylpyrrolidinone. Other suitable liquid aprotic polar solvents may include propylene carbonate, ethylene carbonate, butyrolactone, acetonitrile, benzonitrile, nitromethane, and nitrobenzene. Suitable polar solvents may include water, methanol, acetonitrile, nitromethane, ethanol, propanol, isopropanol, butanol, or the like, may be used. Other non-polar solvents may include benzene, toluene, methylene chloride, carbon tetrachloride, hexane, diethyl ether, and tetrahydrofuran. The solvent may be evaporated before, during and/or after the blending of the composition. After blending, the solvent may re removed by one or both of heating or application of vacuum. Removal of the solvent from the composition may be measured and quantified by an analytical technique such as, infra-red spectroscopy, nuclear magnetic resonance spectroscopy, thermogravimetric analysis, differential scanning calorimetric analysis, and the like.

The graft copolymer compositions may be molded into useful articles by a variety of means, for example injection molding, extrusion molding, rotation molding, foam molding, calendar molding, blow molding, thermoforming, compaction, melt spinning, and the like, to form articles.

The zwitterionic groups, polyalkylene oxide groups, polyalkyleneimine or amide or polyamide groups including the polyarylether may be present as part of the polymer chain or be pendant to it. They may be attached to the polyaryl ether structure through either aromatic, aliphatic or cycloaliphatic radical.

In one embodiment, the zwitterionic groups, polyalkylene oxide groups, polyalkyleneimine, amide or polyamide groups may be attached by reacting compounds containing said groups and a heteroatom-hydrogen bond with a polyarylene ether or polyarylene containing a functional moiety or reactive group. Examples of suitable reactive groups are carboxylic acid halide, sulfonyl acid halide, and alkyl halide. The halide may be bromine, iodine or chlorine. In one embodiment, an amino-, hydroxyl- or thiol-containing polyalkylene ether may react with a polyarylene ether or polyarylene containing an electrophilic group to form a reaction product in accordance with an embodiment of the invention.

Polyethyleneimines may react at one of the active NH groups in its backbone with an electrophilic site on the polyarylene ether or polyarylene. Zwitterionic reaction products may be formed from N,N-dialkylamino acids and polyarylene ethers or polyarylenes bearing alkyl halide groups. Polyarylene ethers or polyarylenes containing dialkylamine groups may react with halo acids to form a zwitterionic group. Amides and polyamides may be formed by reaction of NH or NCH₃ containing amides or polyamide compounds with acyl halide substituted polyarylene ethers or polyarylenes. Amide-containing compounds may be reacted with alkylhalide containing polyarylene ethers or polyarylenes.

The graft polymer or copolymer compositions may be pulled or spun into the form of a fiber or a plurality of fibers. In one embodiment, the fiber may have a diameter in a range of from less than about 1 micrometer to about 10 micrometers, from about 10 micrometers to about 50 micrometers, from about 50 micrometers to about 75 micrometers, from about 75 micrometers to about 150 micrometers, from about 150 micrometers to about 250 micrometers, from about 250 micrometers to about 300 micrometers, from about 300 micrometers to about 450 micrometers, or greater than about 450 micrometers. The fibers may be elastic and have relative high mechanical properties.

Suitable fibers may be hollow fibers. The outer circumference of the fiber relative to an inner surface circumference of the fiber may be expressed as a ratio, so that an outer circumference of 10 micrometers and an inner circumference of 5 would give a ratio of 2. In one embodiment, the ratio of the outer to inner surface circumference is from about 0.1 to about 1, from about 1 to about 2, from about 2 to about 3, from about 3 to about 4, or greater than about 4. In one embodiment, fibers may be arranged to define a mat or a membrane. Further, the membrane may be supported on a second membrane that is itself not formed from a composition including an embodiment of the invention.

In one embodiment, the article may be a sheet or a film. A film has a thickness that is 50 mils or less. A sheet has a thickness of greater than 50 mils. In one embodiment, the film or sheet may be perforate, foraminous, or porous. In one embodiment, the film or sheet is continuous and impermeable. Suitable sheets and films can have a surface topology on one or both major surfaces. Such topology may include patterned microstructures and/or ridges to increase the available surface area or contact area available.

The sheet or film may be porous or permeable so that a fluid can pass or flow therethrough. Such a sheet or film is a type of membrane. The membrane may be rendered permeable by one or more of perforating, stretching, expanding, bubbling, or extracting the base membrane, for example. Suitable methods of making the membrane include foaming, skiving or casting. In one embodiment, a membrane may be formed from woven or non-woven fibers.

A suitable polyarylene ether or polyarylene may be characterized by number average molecular weight (Mₙ) and weight average molecular weight (M_{w}). The various average molecular weights Mₙ and M_{w} are determined by techniques such as gel permeation chromatography. In one embodiment, the Mₙ of the polymer may be in the range from about 10,000 grams per mole (g/mol) to about 1,000,000 g/mol. In another embodiment, the Mₙ ranges from about 15,000 g/mol to about 200,000 g/mol. In another embodiment, the Mₙ ranges from about 20,000 g/mol to about 100,000 g/mol. In another embodiment, the Mₙ ranges from about 30,000 g/mol to about 100,000 g/mol. In another embodiment, the Mₙ ranges from about 25,000 g/mol to about 30,000 g/mol.

In some embodiments, the hollow fiber membrane may include a polyarylene ether or polyarylene blended with at least one additional polymer, in particular, blended with or treated with one or more agents known for promoting biocompatibility. The polymer may be blended with the polyarylene ether or polyarylene to impart different properties such as better heat resistance, biocompatibility, and the like. Furthermore, the additional polymer may be added to the polyarylene ether or polyarylene during the membrane formation to modify the morphology of the phase inverted membrane structure produced upon phase inversion, such as asymmetric membrane structures. In addition, at least one polymer that is blended with the polyarylene ether or polyarylene may be hydrophilic or hydrophobic in nature. In some embodiments, the polyarylene ether or polyarylene is blended with a hydrophilic polymer. A suitable hydrophilic polymer is polyvinylpyrrolidone (PVP). Other suitable hydrophilic polymers may include polyoxazoline, polyethyleneglycol, polypropylene glycol, polyglycol monoester, copolymers of polyethyleneglycol with polypropylene glycol, water-soluble cellulose derivatives, polysorbate, polyethylene-polypropylene oxide copolymers and polyethyleneimines.

Polyvinylpyrrolidone may be obtained by polymerizing a N-vinylpyrrolidone using an addition polymerization reaction. One such polymerization procedure involves the free radical polymerization using initiators such as azobisisobutyronitrile (AIBN), optionally in the presence of a solvent. PVP is also commercially available under the tradenames PLASDONE® from ISP COMPANY or KOLLIDON® from BASF.

When the membrane may include a blend of the polyarylene ether or polyarylene and PVP, the blend may include from about 1 percent to about 5 percent, from about 5 percent to about 10 percent, from about 10 percent to about 15 percent, from about 15 percent to about 20 percent, from about 20 percent to about 25 percent, from about 25 percent to about 40 percent, from about 40 percent to about 50 percent, from about 50 percent to about 60 percent, from about 60 percent to about 70 percent, from about 70 percent to about 80 percent, or greater than about 80 percent polyvinylpyrrolidone based on total blend components in another embodiment.

Polyvinylpyrrolidone may be crosslinked to avoid eluting of the polymer with the medium. Some exemplary methods of crosslinking include, but are not limited to, exposing it to heat, radiation such as X-rays, ultraviolet rays, visible radiation, infrared radiation, electron beams; or by chemical methods such as, but not limited to, treating PVP with a crosslinker such as potassium peroxodisulfate, ammonium peroxopersulfate, at temperatures ranging from about 20 degrees Celsius to about 80 degrees Celsius in aqueous medium at pH ranges of from about 4 to about 9, and for a time period ranging from about 5 minutes to about 60 minutes. The extent of crosslinking may be controlled, by the use of a crosslinking inhibitor, for example, glycerin, propylene glycol, an aqueous solution of sodium disulfite, sodium carbonate, and combinations thereof.

In other embodiments, the polyarylene ether or polyarylene is blended with another polymer. Examples of suitable blend polymers include polysulfone, polyether sulfone, polyvinylidene difluoride (PVDF), polyoxazoline, polyvinylpyrrolidinone, polyether urethane, polyester urethane, polyamide, polyether-amide, polyacrylonitrile and combinations thereof. In one embodiment, the blend polymer is a polysulfone, polyether sulfone, or polyphenylenesulfone, or a copolymer thereof. These materials are prepared by displacement polymerization.

In one particular embodiment, the at least one additional polymer containing an aromatic ring in its backbone and a sulfone moiety as well. Suitable polymers include polysulfones, polyether sulfones or polyphenylenesulfones or copolymers therefrom.

Examples of commercially available polyethersulfones are RADEL R® (a polyethersulfone made by the polymerization of 4,4′-dichlorodiphenylsulfone and 4,4′-biphenol), RADEL A® (PES) and UDEL® (a polyethersulfone made by the polymerization of 4,4′-dichlorodiphenylsulfone and bisphenol A), both available from Solvay Chemicals.

Several techniques for membrane formation include dry-phase separation membrane formation process in which a dissolved polymer is precipitated by evaporation of a sufficient amount of solvent to form a membrane structure; wet-phase separation membrane formation process in which a dissolved polymer is precipitated by immersion in a non-solvent bath to form a membrane structure; dry-wet phase separation membrane formation process which is a combination of the dry and the wet-phase formation processes; thermally-induced phase-separation membrane formation process in which a dissolved polymer is precipitated or coagulated by controlled cooling to form a membrane structure. Further, the membrane may be subjected to a membrane conditioning process, or to a pretreatment process, prior to the membrane's use in a separation application. Representative processes may include thermal annealing to relieve stresses or pre-equilibration in a solution similar to the feed stream the membrane will contact.

The hydrophilicity of the polymer blends may be determined by the contact angle of a liquid such as water on the polymer. Materials exhibiting lower contact angles are considered to be more hydrophilic.

In one embodiment, continuous pores may be produced that extend from one major surface of the sheet or film to the other major surface. Suitable porosity may be greater than about 1 percent. In one embodiment, porosity may be in a range of from about 1 percent to about 2.5 percent, from about 2.5 percent to about 5 percent, from about 5 percent to about 10 percent, from about 10 percent to about 20 percent, from about 20 percent to about 30 percent, from about 30 percent to about 40 percent, from about 40 percent to about 50 percent, from about 50 percent to about 60 percent, from about 60 percent to about 70 percent, or greater than about 70 percent. In one embodiment, pore diameter may be uniform. The pores may be disposed in a predetermined pattern. In one embodiment, suitable pore diameters may have a diameter in a range of from less than about 1 micrometer to about 10 micrometers, from about 10 micrometers to about 50 micrometers, from about 50 micrometers to about 75 micrometers, from about 75 micrometers to about 150 micrometers, from about 150 micrometers to about 250 micrometers, from about 250 micrometers to about 300 micrometers, from about 300 micrometers to about 450 micrometers, or greater than about 450 micrometers. In one embodiment, the average effective pore size of pores in the membrane may be in the micrometer range. Membranes designed for hemodialysis have specific pore sizes so that solutes having sizes greater than the pore sizes may not be able to pass through. Pore size refers to the radius of pores in the active layer of the membrane. Pore size of membranes for ultrafiltration is in a range of from about 0.5 nanometers to about 100 nanometers.

In one embodiment, the membrane may be a three-dimensional matrix or have a lattice type structure including plurality of nodes interconnected by a plurality of fibrils. Surfaces of the nodes and fibrils may define a plurality of pores in the membrane. Surfaces of nodes and fibrils may define numerous interconnecting pathways or pores that extend through the membrane from one to another opposite major side surfaces in a tortuous path.

In one embodiment, the membrane may define many interconnected pores that fluidly communicate with environments adjacent to the opposite facing major sides of the membrane. The propensity of the material of the membrane to permit a liquid material, for example, an aqueous liquid material, to wet out and pass through pores may be expressed as a function of one or more properties. The properties may include the surface energy of the membrane, the surface tension of the liquid material, the relative contact angle between the material of the membrane and the liquid material, the size or effective flow area of pores, and the compatibility of the material of the membrane and the liquid material.

Membranes according to embodiments of the invention may have differing dimensions, some selected with reference to application-specific criteria. Each membrane may be formed from a plurality of sheets or films, may be formed from a weave or mat of fibers, may include a non-inventive layer, or may include two or more of the foregoing. The membrane may have a thickness in the direction of fluid flow that is less than about 10 micrometers; and another membrane may have a thickness in the direction of fluid flow that is greater than about 10 micrometers. In one embodiment, the membrane thickness may be in a range of from about 10 micrometers to about 100 micrometers, from about 100 micrometers to about 1 millimeter, from about 1 millimeter to about 5 millimeters, or greater than about 5 millimeters.

Perpendicular to the direction of fluid flow, the membrane may have a width of greater than about 10 millimeters. In one embodiment, the membrane may have a width in a range of from about 10 millimeters to about 45 millimeters, from about 45 millimeters to about 50 millimeters, from about 50 millimeters to about 10 centimeters, from about 10 centimeters to about 100 centimeters, from about 100 centimeters to about 500 centimeters, from about 500 centimeters to about 1 meter, or greater than about 1 meter. The width may be a diameter of a circular area, or may be the distance to the nearest peripheral edge of a polygonal area. In one embodiment, the membrane may be rectangular, having a width in the meter range and an indeterminate length. That is, the membrane may be formed into a roll with the length determined by cutting the membrane at predetermined distances during a continuous formation operation.

A membrane prepared according to embodiments of the invention may have one or more predetermined properties. Such properties may include one or more of a wettability of a dry-shipped membrane, a wet/dry cycling ability, filtering of polar liquid or solution, flow rate of aqueous liquid or solution, surface electronegativity, flow and/or permanence under low pH conditions, flow and/or permanence under high pH conditions, flow and/or permanence at room temperature conditions, flow and/or permanence at elevated temperature conditions, flow and/or permanence at elevated pressures, transparency to energy of predetermined wavelengths, transparency to acoustic energy, or support for catalytic material. Permanence refers to the ability of the coating material to maintain function in a continuing manner, for example, for more than 1 day or more than one cycle (wet/dry, hot/cold, high/low pH, and the like).

A property of at least one embodiment may include a resistance to temperature excursions in a range of from about 100 degrees Celsius to about 125 degrees Celsius, for example, in autoclaving operations. In one embodiment, resistance to ultraviolet (UV) radiation may allow for sterilization of the membrane without loss of properties. Of note is an alternative embodiment in which cross-linking of the coating composition may be initiated or facilitated by exposure to an irradiation source, such as a UV source, where UV initiators may compete with UV absorbing compositions, if present.

Flow rate of fluid through the membrane may be dependent on one or more factors. The factors may include one or more of the physical and/or chemical properties of the membrane, the properties of the fluid (e.g., viscosity, pH, solute, and the like), environmental properties (e.g., temperature, pressure, and the like), and the like. In one embodiment, the membrane may be permeable to vapor rather than, or in addition to, fluid or liquid. A suitable vapor transmission rate, where present, may be in a range of less than about 1000 grams per square meter per day (g/m²/day), from about 1000 g/m²/day to about 1500 g/m²/day, from about 1500 g/m²/day to about 2000 g/m²/day, or greater than about 2000 g/m²/day. In one embodiment, the membrane may be selectively impermeable to vapor, while remaining permeable to liquid or fluid.

The membrane may be used to filter water. In one embodiment, the water may flow through the membrane at flow rate that is greater than about 5 mL/min-cm at a pressure differential of 27 inches Hg at room temperature after 10 wet/dry cycles. In one embodiment, the water may flow through the membrane at flow rate that is greater than about 5 mL/min-cm at a pressure differential of 27 inches Hg at about 100 degrees Celsius after 10 wet/dry cycles. In one embodiment, the water may flow through the membrane at flow rate that is greater than about 10 mL/min-cm at a pressure differential of 27 inches Hg at room temperature after 10 wet/dry cycles. In one embodiment, the water may flow through the membrane at flow rate that is greater than about 10 mL/min-cm at a pressure differential of 27 inches Hg at 100 degrees Celsius after 10 wet/dry cycles.

The membrane surface may have a bulk electronegativity property of less than −5 as measured by Zeta potential in millivolts. In one embodiment, the Zeta potential is in a range of from about −5 mV to about −25 mV, from about −25 mV to about −35 mV, from about −35 mV to about −55 mV, from about −55 mV to about −65 mV, from about −65 mV to about −70 mV, and greater than −71 mV.

In one embodiment, the membrane may be absorbent, such as water or bodily fluid absorbent. Absorbent may include insignificant amounts of fluid influx and outflow when maintaining equilibrium with a fluidic environment. However, absorbent is distinguishable, and distinguished from, flowable. Flow includes an ability of liquid or fluid to flow from a first surface through the membrane and out a second surface. Thus, in one embodiment, the membrane may be operable to have a liquid or fluid flow through at least a portion of the material in a predetermined direction. The motive force may be osmotic or wicking, or may be driven by one or more of a concentration gradient, pressure gradient, temperature gradient, or the like.

The membrane may have a plurality of sub layers. The sub layers may be the same as, or different from, each other. In one aspect, one or more sub layer may include an embodiment of the invention, while another sub layer may provide a property such as, for example, reinforcement, selective filtering, flexibility, support, flow control, and the like.

Other suitable applications may include liquid filtration; polarity-based chemical separations; pervaporization; gas separation; dialysis separation; industrial electrochemistry such as chloralkali production and electrochemical applications; super acid catalysts; affinity chromatography for protein, peptide, antibody, or DNA purification; virus removal; or use as a medium in enzyme immobilization.

Microfiltration membranes may filter a suspension of fine particles or colloidal particles with linear dimensions in a range of from about 20 nanometers to about 10,000 nanometers. Ultrafiltration membranes may have pore sizes of less than about 100 nanometers on average, and may retain species in the molecular weight range of from about 300 daltons to about 500,000 daltons. Suitable rejected species include sugars, biomolecules, polymers and colloidal particles.

Nanofiltration membranes have received increasing attention in low-pressure water desalination. These membranes are often negatively charged and reject salts through charge repulsion (Donnan exclusion). In addition, organic species with molecular weights in the range of about 200 daltons to about 500 daltons are rejected.

Hyperfiltration and reverse osmosis (RO) may use a relatively dense membrane. Such dense membrane may have pores or perforations of sufficient size or chemical activity such that small molecules such as salts and low molecular weight organics are treated differently from water in contact with the membrane surface. Suitable RO membranes according to embodiments of the invention may include high pressure RO membranes for destination of seawater (5 MPa to about 10 MPa driving pressure( ); medium pressure RO for desalination of brackish water (1 MPa to about 5 MPa driving pressure); and nanofiltration or “loose” RO for partial demineralization of water (0.3 MPa to about 1 MPa driving pressure, 0-20% NaCl rejection).

Ultrafiltration and microfiltration membranes according to embodiments of the invention may be produced by (1) casting a solution or a mixture including a suitably high molecular weight polymer, a solvent, and a nonsolvent into a thin film on a fibrous support, and (2) precipitating the polymer through one or more of the following mechanisms: (a) evaporation of the solvent and nonsolvent (dry process); (b) exposure to a nonsolvent vapor, such as water vapor, which absorbs on the exposed surface (vapor phase-induced precipitation process); (c) quenching in water (wet process); or (d) thermally quenching a hot film so that the solubility of the polymer is suddenly greatly reduced (thermal process).

Both ultrafiltration and microfiltration membranes have been used as interlayer supports in thin film composite membranes. These membranes are prepared by a process in which an ultra- or microfiltration membrane (often supported by a fibrous non-woven support) is imbibed with a first reactive monomer or monomers in an aqueous solution, then coated with a water insoluble solution including a second monomer or monomers reactive with the first. The thin film membrane forms at the solution interface. These membranes may be used for numerous water purifications, most notably nano-filtration, reverse osmosis, and hyperfiltration.

An RO membrane according to one embodiment may include a polyamide thin film cast or polymerized onto a porous ultra-filtration or microfiltration membrane. In one example, the polyamide thin film is prepared by reaction of a nucleophilic monomer dissolved in water and the solution imbibed into the porous support. A suitable nucleophilic monomer may include m-phenylene diamine (MPD). A second electrophilic monomer may be dissolved in a non-water soluble solvent and coated onto the surface of the imbibed support. A suitable electrophilic monomer may include 1,3,5-trimesoyl chloride (TMC), and a suitable non-water soluble solvent may include a hydrocarbon such as ISOPAR® G or hexane. At the interface, near the surface of the porous support, occurs a rapid interfacial reaction between the electrophilic and nucleophilic monomers, depositing a crosslinked polyamide thin film.

The thin film membrane may have a rough surface topology with rugosities of greater than about 10 nanometers. In one embodiment, the thin film average thickness may be in a range of from about 20 nanometers and about 300 nanometers. A number of nucleophilic and electrophilic monomers, oligomers, and polymers may be used as well as solvent mixtures and additives to affect the roughness, thickness, charge and chemical composition of the thin film. These variations may control the selectivities, fluxes, hydrophilicities, scaling and biofouling of the thin film membrane.

The electrophilic monomers include molecules containing at least 2 of a member or members selected from the group consisting of acid halide, isocyanate, carbonyl halide, haloformate, anhydride, phosphorylhalide and sulfonylhalide groups, examples include 1,3 and 1,4-benzene dicarboxylic acid halides; 1,2,4 and 1,3,5-benzene tricarboxylic acid halides; 1,3- and 1,4-cyclohexane dicarboxylic acid halides; 1,2,3,5-cyclopentanetetracarboxylic acid chloride, 1,2,4- and 1,3,5-cyclohexane tricarboxylic acid halides; trimellitic anhydride carboxylic acid halides; benzene tetracarboxylic acid halides; pyromellitic acid dianhydride; sebacic acid halides; azelaic acid halides; adipic acid halides; dodecanedioic acid halides; acid halide-terminated polyamide oligomers; 2,4-toluene diisocyanate; 4,4′-methylenebis(phenylisocyanate); naphthalene di-, tri- and tetra-isocyanates; hexamethylene diisocyanate; phenylene diisocyanates; haloformyloxy benzene dicarboxylic acid halides; 1-isocyanatobenzene 3,5-dicarboxylic acid halides; benzene di-, tri- and tetrasulfonylchlorides such as 1,3- and 1,4-benzenedisulfonylchloride, 1,3,5-benzenetrisulfonylchloride and naphthalene di-, tri- and tetrasulfonyl chlorides such as 1,3,6(7)-napthalene trisulfonylchloride, 4,4′-biphenylenedisulfonyl halide; dimethyl piperazine-N,N′-diformyl halides; piperazine-N,N′-diformyl halides; chloroformates such as xylylene glycol dihaloformates; benzene diol di-haloformates; benzene triol trihaloformates; phosgene; diphosgene; triphosgene; N,N′-carbonyl diimidazole; isocyanuric acid-N,N′,N″-triacetyl halide; isocyanuric acid-N,N′,N″-tripropionyl halide; and cyclopentane tetracarboxylic acid halides.

Nucleophilic monomers include polyethylenimines; piperazine, methylpiperazine, dimethylpiperazine, homopiperazine, ethylene diamine, tetramethylenediamine, amine terminated polyamide oligomers, amine terminated polyamides, amine terminated polypropylene oxide, amine terminated polyethylene oxide, amine terminated polytetrahydrofuran, and amine terminated polypropylene oxide-polyethylene oxide random and block copolymers, reaction products of amines with a poly epihalohydrin; di-aminocyclohexane and triaminocyclohexane, such as 1,3-diaminobenzene and 1,4-diaminobenzene; di- and tri and tetraaminobenzenes such as 1,3-diaminobenzene and 1,4-diaminobenzene, and 1,3,5-triaminobenzene and 1,2,4-triaminobenzene; di-, tri and tetraamino benzanilides, such as 4,4′diamino-, 3,4′-diamino-, 3,3′-diamino, 3,5,3′-triamino, 3,5,3′,5′-tetraaminobenzanilides; xylenediamines such as 1,3 and 1,4-xylylene diamines; chlorophenylene diamines; tetrakis aminomethyl methane, diaminodiphenyl methanes; N,N′-diphenyl ethylene diamine; aminobenzamides; aminobenzhydrazides; bis(alkyl amino)phenylene diamines; melamine; and tris(aziridinyl)propionates.

Embodiments of the invention may include a polyarylene ether or polyarylene having a bound zwitterionic group. In another embodiment, a polyarylene ether or polyarylene has bound polyalkylene ether groups. In one embodiment, a polyarylene ether or polyarylene has bound polyethyleneimine groups. In another embodiment, a polyarylene ether or polyarylene has one or more bound amide or polyamide groups. In another embodiment, a polyarylene ether or polyarylene includes a member selected from the group consisting of zwitterionic, polyalkylene ether, polyethyleneimine, amide and polyamide groups for membrane applications including ultrafiltration, microfiltration, hyperfiltration, hemofiltration and hemodialysis. In one embodiment, a process is provided that functionalizes a polyarylene ether with a member selected from the group consisting of zwitterionic, polyalkylene ether, polyethyleneimine, amide and polyamide containing compound. In one embodiment, a polyarylene ether or polyarylene has bound zwitterionic groups for membrane applications including ultrafiltration, microfiltration, hyperfiltration, hemofiltration and hemodialysis.

### EXAMPLES

The following examples illustrate methods and embodiments in accordance with the invention, and as such should not be construed as imposing limitations upon the claims. Unless specified otherwise, all ingredients may be commercially available from such common chemical suppliers as Alpha Aesar, Inc. (Ward Hill, Mass.), Sigma Aldrich, Spectrum Chemical Mfg. Corp. (Gardena, Calif.), and the like.

### Example 1

### Preparation of Tri-n-butyltinhydride Reduced Poly(2,6-dimethyl-1,4-phenylene ether)

A 12 liter three-neck round-bottom flask equipped with a mechanical stirrer, thermometer and a reflux condenser with a nitrogen bypass is charged with 6 liters of phenyl ether and 100 ml of tri-n-butyltinhydride. Under vigorous stirring conditions 1200 grams (g) of polyphenylene ether (viscosity (η=0.551 deciliter per gram (dl/g), Mn=21,600 gram per mole (g/mol), Mw=61600 gram per mol (g/mol), percent N=0.1225, percent OH=0.0713) is added. The reaction mixture is heated to 200-210 degrees Celsius and maintained at that temperature for 5 hours. A fine grey precipitate forms. The solution is cooled and 3 liter of chloroform is added to facilitate filtration. The polymer solution is filtered three times through CELITE 270, with additional chloroform being added to facilitate filtration. The filtrate is then precipitated into methanol and washed repeatedly with methanol and acetone and dried in vacuo. The product is dissolved in chloroform and precipitated again into methanol. The product is dried in vacuo. ¹H- and ¹³C-NMR analysis are consistent with the expected product and the removal of residual alkylamine groups bound to the terminus (viscosity (visc.=0.503 deciliter per gram (dl/g), Mn=29,800, Mw=61,100, percent N=0.0470, percent OH=0.1340). Reduction in the amine content is observable that is consistent the reduction of the terminal alkylamine groups.

### Example 2

### Preparation of Benzoate-Capped, tri-n-butyltinhydride Reduced poly(2,6-dimethyl-1,4-phenylene ether)

A 5-liter three-neck round-bottom flask equipped with a mechanical stirrer, thermometer and a reflux condenser with a nitrogen bypass is charged with 3 liters of toluene and 600 grams (g) of the polyphenylene ether from Example 1. With vigorous stirring, 140.6 g of benzoyl chloride and 111.1 g of N,N′-dimethylbutylamine is added. The reaction mixture is heated to 100 degrees Celsius and maintained at that temperature for 12 hours. The solution precipitates into methanol and is dried in vacuo. The product dissolves in chloroform and is precipitated again into methanol. The product is dried in vacuo. ¹H- and ¹³C-NMR analysis are consistent with the expected product (viscosity (η=0.553 deciliter per gram (dl/g), Mn=32,700, Mw=63,700, percent N=0.0332, percent OH=0.0185). Reduction in the hydroxyl content is consistent with end-capping of the terminal groups.

### Example 3

### Preparation of Methyl-Brominated tri-n-butyltinhydride Reduced poly(2,6-dimethyl-1,4-phenylene ether)

To 500 milliliter (ml) of carbon tetrachloride 100 grams (330 millimole repeat unit) of polyphenylene ether from Example 2 is added. After the polyphenylene ether had dissolved, 58.75 grams (132 millimole, 40 mol percent of PPO repeat units) N-bromosuccinimide is added. The solution is heated to reflux for 4 hours. After such time the solution is cooled and the polymer precipitates into methanol. The product is isolated by filtration and dried in vacuo. Mn=31,130 gram per mole (g/mol), Mw=34,400 gram per mole (g/mol), percent methyl groups brominated=35.

### Example 4

### Preparation of Microporous Methyl Group-Brominated PPE Membrane

The PPE from Example 3 dissolves in N-methylpyrrolidinone at a concentration of 25 percent solids. The solution is cast onto a glass plate with a 10 mil gap casting knife. The glass plate is submerged immediately into deionized water at room temperature. The resulting membrane may be porous.

### Examples 5-11

### Amine Treatment of the Microporous Methyl Group-Brominated PPE Membrane

The membrane of Example 4 is cut into seven 2.5 cm×2.5 cm specimens to form Examples 5-11. Five of the specimens are placed into 10 percent aqueous solutions of various amines (Examples 7-11). The specimens are removed from the solution and soaked in deionized water bath for 20 minutes and a second deionized water bath for an additional 20 minutes and dried in an oven at 80 degrees Celsius. The treated specimens are compared to two controls (Examples 5-6). The first and second controls are a brominated PPE control (Examples 5-6) and are soaked in deionized water bath for 20 minutes, and the second control (Example 6) further is soaked in a second deionized water bath for an additional 20 minutes, and both the first and second controls are dried in an oven at 80 degrees Celsius. The contact angle is tested for each of the specimens and the results are given in Table 1. Treatment with amines may reduce the contact angle of the membrane. Polyethyleneimine treated polyphenylene ether is observable to have the smallest contact angle. The results are shown in Table 2.

TABLE 2
Results for Examples 5-11

| | | Contact Angle |
|---|---|---|
| Example | Treatment | (degrees) |
| 5 | None | 87.3 |
| 6 | Deionized Water | 80.6 |
| 7 | 10 percent aqueous Polyethyleneimine | 68.0 |
| | (Mn = 2000 g/mol) | |
| 8 | 10 percent aqueous Acetyl piperazine | 71.8 |
| 9 | 10 percent aqueous Oxazolidinone | 81.1 |
| 10 | 10 percent aqueous Sarcosine dimethylamide | 72.4 |
| 11 | 10 percent aqueous Morpholine | 77.9 |

### Example 12

### Preparation of Supported Microporous Bromomethylated PPO Membrane

A first solution is produced that is 20 weight percent of the reaction product from Example 3 and 5 weight percent polyethylene glycol (PEG Mₙ=200 gram per mole (g/mol)) in N-methylpyrrolidinone (balance). The solution is cast onto a non-woven polyester fabric with 10 mil gap casting knife using a drawdown machine at a rate of 7.5 feet per minute (ft/min). After coating, the membrane is immersed into water bath kept at 7-10 degrees Celsius for 3 minutes. The coated fabric is stored in deionized water at room temperature. A-value=276.5, contact angle=88.7 degrees. A second solution is produced that is 18 percent of the reaction product from Example 3 and 5 weight percent polyethylene glycol (PEG Mₙ=200 gram per mole (g/mol)) in N-methylpyrrolidinone (balance). The second solution is phase inverted in the same fashion as the first solution. A-value=654.8, a contact angle=88.4 degrees is observable.

### Example 13

### Preparation of Reverse Osmosis Thin Film Composite (TFC) Membrane

The coated support layer from Example 12 is washed 3 times with deionized water to remove residual solvent, and is placed into an aluminum frame. An aqueous solution of 2 weight percent m-phenylene diamine, 2 weight percent triethylamine, and 4.6 weight percent camphorsulfonic acid, balance water, is poured onto the support layer for 30 seconds. The surface is dried off with a squeegee and 0.12 weight percent solution of trimesoyl chloride in ISOPAR G is poured onto the support layer for 30 seconds, which results in formation of the active skin layer over the surface of coated support layer. The resulting thin film composite membrane is placed into an air-circulating convection oven at 110 degrees Celsius for 5 minutes and then re-immersed in deionized water. The membrane is stored in deionized water until tested.

### Example 14

### Membrane Performance Testing

The thin film composite membrane from Example 13 is cut into samples that are tested with 2000 parts per million (ppm) aqueous solution of NaCl to determine their permeation performances with a crossflow STERLITECH CF042 cell. The operating pressure differential across the membrane is 1.55 megaPascals (MPa). Flux is measured by weighing of the permeate that penetrated through the membrane per unit of time, and solute rejection is calculated from the concentrations of the feed and permeate solutions using the following equation

Rejection=100×(C_{f}−Cₚ)/C_{f}

where C_{f} and Cₚ are the concentrations of the feed and permeate solutions, respectively. The tested thin film composite membranes have rejections of 38.7 percent before chlorination and 43.7 percent after chlorination.

### Example 15

### Bromination of Untreated poly(2,6-dimethyl-1,4-phenylene ether)

Polyphenylene ethers obtained from General Electric Plastics, (Selkirk, N.Y.), having intrinsic viscosities (η) of 0.40 deciliter per gram (dl/g) (Mn=19,200, Mw=41,100), and 1.05 deciliter per gram (dl/g) (Mn=30,400, 224,000) are brominated by a process like that described in Example 3. Samples are taken as the polymerization proceeded, and those samples are precipitated into methanol and dried in vacuo. The level of methyl group bromination is determined by ¹H-NMR by comparison of the integrals of the 4.4 parts per million (ppm) resonance (CH₂Br) to the methyl 2.4 parts per million (ppm) resonance (CH₃). The polymer samples dissolve in N-methylpyrrolidinone at 25 percent solids, and are allowed to stand overnight at room temperature. Gelation of the solutions is tested using the tilt method described in the Polymer Handbook, Bandrup, J. and Immergut, E. H. eds. New York. Wiley Interscience 1989; Chapter VII. Gelation Properties of Polymers, A. Hiltner. The results are shown in Table 3.

All samples initially dissolve by briefly heating at temperatures of about 100 degrees Celsius. Upon cooling to room temperature and allowing to stand for 24 hours some of the samples gel. Gelling makes the materials impossible to process into membranes. Based on these results, polyphenylene ethers having intrinsic viscosities between 0.40 IV and 1.05 IV require greater than 25 percent bromination to produce processable NMP solutions at 25 percent polymer concentration.

TABLE 3
Results for gellation.

| | | | | Gelation of | |
|---|---|---|---|---|---|
| Rxn | percent | | | 25% NMP | |
| time | Benzylic | | | solution after | Chloroform |
| (seconds) | Bromination | Mn | Mw | 24 hours | Insoluble |
| 0 | 0 | 30429 | 223978 | Y | N |
| 20 | 5.84 | 34767 | 337556 | Y | N |
| 40 | 7.86 | 40336 | 396054 | Y | N |
| 60 | 9.39 | 38320 | 413719 | Y | Y |
| 90 | 14.35 | 38581 | 463469 | Y | Y |
| 120 | 20.22 | 35528 | 463992 | Y | Y |
| 180 | 25.49 | 36798 | 499143 | N | Y |
| 240 | 27.28 | 34882 | 588122 | N | Y |
| 1440 | 42.1 | 26126 | 219310 | N | Y |

### Example 16

### Preparation of Poly(2,6-dimethyl-1,4-phenylene oxide)

A five-neck, 1-liter round bottom flask is equipped with an overhead stirrer, thermometer, and an oxygen diptube. The flask is charged with 0.125 grams (0.725 millimole) of N,N′-di-t-butylethylenediamine (DBEDA), 1.6 grams (15.8 millimole) of N,N-dimethylbutylamine (DMBA), 0.5 grams (3.87 millimole) of di-n-butylamine (DBA), 0.14 grams of methyltri-(C₈-C₁₀)-alkylammonium chloride obtained as ADOGEN 464, 100 grams of toluene, and 7.5 grams of a 50 percent toluene solution of 2,6-dimethylphenol (7.50 grams solution, 3.75 grams monomer, 31 millimoles monomer). A 0.425 gram amount of copper catalyst (produceable from a stock of 14.3 grams of cuprous oxide to 187.07 grams of 48 percent hydrobromic acid) is added to the flask. With vigorous stirring, oxygen passes through the solution at 2 standard cubic feet per minute (SCFM) and a solution of 2,6-dimethylphenol (67.50 grams solution, 33.75 grams solution, 277 millimoles monomer). The reaction mixture is stirred for 3 hours in a water bath to maintain a temperature of less than 35 degrees Celsius. The solution is treated with 10 milliliters of glacial acetic acid to quench the catalyst. The polymer is isolated from the organic phase by methanol precipitation. The resulting wet cake dissolves in toluene and reprecipitates into methanol. The isolated solid is dried overnight at 70 degrees Celsius under vacuum. Mn=22,004 g/mol; Mw=50,213 g/mol; Tg=210 degrees Celsius.

### Example 17

### Preparation of Poly(2-methyl-6-phenyl-1,4-phenylene ether)

A five-neck, 1-liter round bottom flask is equipped with an overhead stirrer, thermometer, and an oxygen diptube. The flask is charged with 0.125 grams (0.725 millimole) of N,N′-di-t-butylethylenediamine (DBEDA), 1.6 grams (15.8 millimole) of N,N-dimethylbutylamine (DMBA), 0.5 grams (3.87 millimole) of di-n-butylamine (DBA), 0.14 grams of methyltri-(C₈-C₁₀)-alkylammonium chloride obtained as ADOGEN 464, 100 grams of toluene, and 7.5 grams of a 50 percent toluene solution of 2-methyl-6-phenylphenol (10.28 grams solution, 5.14 grams monomer, 28 millimoles monomer). A 0.425 gram amount of copper catalyst (produced from a stock solution prepared by adding 14.3 grams of cuprous oxide to 187.07 grams of 48 percent hydrobromic acid) is added to the flask. With vigorous stirring, oxygen passes through the solution at 2 standard cubic feet per minute (SCFM) and a solution of 2-methyl-6-phenylphenol (102.8 grams solution, 51.40 grams solution, 278 millimoles monomer). The reaction mixture is stirred for 3 hours using a water bath to maintain a temperature of less than 35 degrees Celsius. The solution is treated with 10 milliliters of glacial acetic acid to quench the catalyst. The solution is decanted from the aqueous phase that forms from the reaction mixture. The polymer is isolated from the organic phase by methanol precipitation. The resulting wet cake dissolves in toluene and reprecipitates into methanol to form an isolated solid. The isolated solid dries overnight at 70 degrees Celsius under vacuum. Mn=39,551 g/mol; Mw=79,978 g/mol; Tg=183 degrees Celsius.

### Example 18

### Preparation of poly(2,6-dimethyl-1,4-phenylene-co-2-methyl-6-phenyl-1,4-phenylene ether) Using an Equimolar Mixture of 2,6-dimethylphenol and 2-methyl-6-phenylphenol as Comonomers

A five-neck, 1-liter round bottom flask is equipped with an overhead stirrer, thermometer, and an oxygen diptube. The flask is charged with 0.125 grams (0.725 millimole) of DBEDA, 1.6 grams (15.8 millimoles) of DMBA, 0.5 grams (3.87 millimoles) of DBA, 0.14 grams of Adogen 464, 100 grams of toluene, and 5.6875 grams of a 50 percent toluene solution of 2-methyl-6-phenylphenol (2.84 grams, 15.6 millimoles; 10 percent of the total 2-methyl-6-phenylphenol) and 3.75 grams of a 50 percent toluene solution of 2,6-dimethylphenol (1.88 grams, 15.6 millimoles; 10 percent of the total 2,6-dimethylphenol). A 0.425 gram amount of copper catalyst (produced from a stock solution prepared by adding 14.3 grams of cuprous oxide to 187.07 grams of 48 percent hydrobromic acid) is added to the flask. An addition funnel is charged with 51.2 grams of a 50 percent toluene solution of 2-methyl-6-phenylphenol (25.59 grams, 140.6 millimoles, 90 percent of total 2-methyl-6-phenylphenol) and 33.8 grams of a 50 percent toluene solution of 2,6-dimethylphenol (16.88 grams, 140.6 millimoles, 90 percent of the total 2,6-dimethylphenol).

With vigorous stirring, oxygen passes through the solution at 2 SCFM while the toluene solution of 2-methyl-6-phenylphenol/2,6-dimethylphenol is added dropwise to the reaction mixture over a period of 30 minutes. After the addition of the toluene solution is complete, the reaction mixture is stirred for an additional 2 hours. The solution is treated with 10 milliliters of glacial acetic acid to quench the catalyst. A polymer is isolated from the solution by methanol precipitation to form an isolated filter cake. The isolated filter cake redissolves into toluene and reprecipitated in methanol. Testing of the dried cake reveals the properties of (Mn=46,169 g/mol; Mw=74,761 g/mol; Tg=205 degrees Celsius).

### Examples 19, 20, 21

### Gelation Determinations

N-methylpyrrolidinone (NMP) solutions of the reaction products from Examples 16, 17, 18: Gelation of the solution are determined using the tilt method described in A. Hiltner in J. Brandup and E. H. Immergut, Eds., “Polymer Handbook”, Wiley-Interscience, New York: 1989, page VII/591. Table 4 includes gelation properties of Examples 19-21, “Y” means gelling occurred at 25 degrees Celsius, “N” means no gelling occurred at 25 degrees Celsius within 24 hours.

TABLE 4
Gellation results.

| | Example | Example | Example |
|---|---|---|---|
| | 19 | 20 | 21 |
| Poly(2,6-dimethyl-1,4- | 25 g | — | — |
| phenylene ether) | | | |
| (From Example 16) | | | |
| Poly(2-methyl-6-phenyl-1,4- | — | 25 g | — |
| phenylene ether) | | | |
| (From Example 17) | | | |
| Poly(2-methyl-6-phenyl-1,4- | — | — | 25 g |
| phenylene-co-2,6-dimethyl-1,4- | | | |
| phenylene ether) (50/50 mol | | | |
| percent comonomer repeat units) | | | |
| (From Example 18) | | | |
| N-methylpyrrolidinone | 75 g | 75 g | 75 g |

Gelation Properties

| | | | |
|---|---|---|---|
| NMP gelation after 24 h at | Y | N | N |
| 10 percent solids | | | |
| NMP gelation after 24 h at | Y | N | N |
| 20 percent solids | | | |
| NMP gelation after 24 h at | Y | N | N |
| 25 percent solids | | | |

### Example 21

### Preparation of a Asymmetric Composite Membrane from Poly(2-methyl-6-phenyl)phenol (From Example 17)

To 100 milliliter of N-methylpyrrolidinone is added 25 grams of poly(2-methyl-6-phenyl)phenol. With constant stirring, the polymer dissolves in the N-methylpyrrolidinone and the resulting solution is cast onto a polyester support. The solution is immersed into a bath of deionized water to produce a porous composite membrane.

### Example 22

### Preparation of a Asymmetric Composite Membrane from Poly(2-methyl-6-phenyl-1,4-phenylene-co-2,6-dimethyl-1,4-phenylene ether) (50/50 Mole Percent Comonomer Repeat Units) (From Example 18)

To 100 milliliter of N-methylpyrrolidinone is added 25 grams of poly(2-methyl-6-phenyl)phenol. With constant stirring, the polymer dissolves in the N-methylpyrrolidinone to form a solution, and the solution is cast onto a polyester support. The solution is immersed into a bath of deionized water to produce a porous composite membrane.

### Examples 23-27

### Zwitterion Treatment of the Microporous Methyl Group-Brominated PPE Membrane

The membrane of Example 4 is cut into five 1 inch×1 inch specimens (Examples 5, 6 and 23-25). Three of the specimens are placed into various 10 percent aqueous solutions of precursors (Examples 23-25). The specimens are removed from the solution and are soaked in a first deionized water bath for 20 minutes, removed, and soaked in a second deionized water bath for an additional 20 minutes. The specimens are removed and dried in an oven at 80 degrees Celsius. The treated specimens are compared to two controls (Examples 5-6). The first control is a reaction product from Example 5; and the second control is a reaction product from Example 6. The contact angle is tested for each of the specimens and controls, and the testing results are given in Table 5.

TABLE 5
reduction of the contact angle of the membrane relative to controls

| | | Contact Angle |
|---|---|---|
| Example | Treatment | (degrees) |
| 5 | None | 87.3 |
| 6 | Deionized Water | 80.6 |
| 23 | 10 percent aqueous 4-(2-hydroxyethyl)-1- | Less than control |
| | piperazineethanesulfonic acid | |
| 24 | 10 percent aqueous piperazine-N,N′- | Less than control |
| | bis(2-ethanesulfonic acid) | |
| 25 | 10 percent aqueous N,N-dimethyl glycine | Less than control |

In the following specification and the claims which follow, reference will be made to a number of terms that have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. For example, free of solvent or solvent-free, and like terms and phrases, may refer to an instance in which a significant portion, some, or all of the solvent has been removed from a solvated material.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity may be expected, while in other circumstances the event or capacity cannot occur—this distinction is captured by the terms “may” and “may be”.

Reference is made to substances, components, or ingredients in existence at the time just before first contacted, formed in situ, blended, or mixed with one or more other substances, components, or ingredients in accordance with the present disclosure. A substance, component or ingredient identified as a reaction product, resulting mixture, or the like may gain an identity, property, or character through a chemical reaction or transformation during the course of contacting, in situ formation, blending, or mixing operation if conducted in accordance with this disclosure with the application of common sense and the ordinary skill of one in the relevant art (e.g., chemist). The transformation of chemical reactants or starting materials to chemical products or final materials is a continually evolving process, independent of the speed at which it occurs. Accordingly, as such a transformative process is in progress there may be a mix of starting and final materials, as well as intermediate species that may be, depending on their kinetic lifetime, easy or difficult to detect with current analytical techniques known to those of ordinary skill in the art.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have utility distinct from the utility of the reaction product or final material. Other subsequent changes, transformations, or reactions may result from bringing the specified reactants and/or components together under the conditions called for pursuant to this disclosure. In these other subsequent changes, transformations, or reactions the reactants, ingredients, or the components to be brought together may identify or indicate the reaction product or final material.

The embodiments described herein are examples of compositions, structures, systems and methods having elements corresponding to the elements of the invention recited in the claims. This written description may enable those of ordinary skill in the art to make and use embodiments having alternative elements that likewise correspond to the elements of the invention recited in the claims. The scope of the invention thus includes compositions, structures, systems and methods that do not differ from the literal language of the claims, and further includes other structures, systems and methods with insubstantial differences from the literal language of the claims. While only certain features and embodiments have been illustrated and described herein, many modifications and changes may occur to one of ordinary skill in the relevant art. The appended claims cover all such modifications and changes.

1. A membrane formed from a composition, wherein the composition comprises a polyarylene ether polymer or copolymer comprising a zwitterion; or comprises a polyarylene polymer or copolymer comprising a zwitterion.

2. The membrane as defined in claim 1, wherein the membrane has a surface that is hydrophilic.

3. The membrane as defined in claim 2, wherein the membrane has a surface with a contact angle of less than about 65 as measured using sessile drop method.

4. The membrane as defined in claim 3, wherein the membrane has a surface with a contact angle of less than about 35 as measured using sessile drop method.

5. The membrane as defined in claim 1, wherein the membrane has a glass transition temperature that is greater than about 120 degrees Celsius.

6. The membrane as defined in claim 1, wherein the membrane has a thickness that less than about 1 millimeter.

7. The membrane as defined in claim 6, wherein the membrane has a thickness that less than about 10 micrometers.

8. The membrane as defined in claim 1, wherein the membrane has a porosity of greater than about 10 percent by volume.

9. The membrane as defined in claim 1, wherein the membrane has a porosity of less than about 50 percent by volume.

10. The membrane as defined in claim 1, wherein the membrane has a surface that is biocompatible.

11. The membrane as defined in claim 1, wherein the membrane has a surface that is hemocompatible.

12. The membrane as defined in claim 1, wherein the zwitterion is one of a plurality of zwitterions that are present in an amount sufficient to increase the hydrophilicity of the composition to less than about 55 degrees water contact angle.

13. The membrane as defined in claim 12, wherein the zwitterion is one of a plurality of zwitterions that are present in an amount sufficient to increase the hydrophilicity of the composition to less than about 35 degrees water contact angle.

14. The membrane as defined in claim 1, the membrane has a surface and the zwitterion is a pendant moiety extending from the surface.

15. The membrane as defined in claim 14, wherein the pendant moiety that comprises at least one atom of sulfur, phosphorus, carbon, or nitrogen.

16. The membrane as defined in claim 15, wherein the pendant moiety comprises an amino group or an alkaloid group.

17. The membrane as defined in claim 1, wherein the zwitterion comprises at least one atom of sulfur.

18. The membrane as defined in claim 1, wherein the zwitterion comprises at least one atom of phosphorus.

19. The membrane as defined in claim 1, wherein the zwitterion comprises at least one atom of carbon.

20. A water treatment system, comprising:
the membrane as defined in claim 1, wherein the membrane is a filtration membrane that passes a flow of water from an aqueous solution of relatively high solute concentration to a solution of relatively low solute concentration in response to a pressure differential across the membrane.

21. The water treatment system as defined in claim 20, wherein the membrane has a salt rejection percentage of greater than 75 percent.

22. The water treatment system as defined in claim 20, wherein the membrane is a reverse osmosis membrane comprising a plurality of layers and one of the plurality of layers is a surface layer, and the surface layer comprises a reaction product of a nucleophilic monomer and an electrophilic monomer.

23. The water treatment system as defined in claim 22, wherein the reaction product is covalently bonded to the membrane.

24. The water treatment system as defined in claim 20, wherein in the membrane blocks a flow of ions therethrough.

25. The water treatment system as defined in claim 24, wherein the ions comprise metal.

26. The water treatment system as defined in claim 24, wherein the ions comprise boron or arsenic.

27. A desalination unit comprising the water treatment system as defined in claim 20.

28. An ultrafiltration membrane, comprising the membrane as defined in claim 1 having a plurality of pores, and the pores have an average pore size in a range of from about 0.5 nanometers to about 100 nanometers.

29. The ultrafiltration membrane as defined in claim 28, wherein the reaction product is covalently bonded to the membrane.

30. A hemodialysis apparatus comprising the membrane as defined in claim 1, wherein the hemodialysis apparatus is capable of separating one blood component from another blood component.

31. A bioseparation apparatus comprising the membrane as defined in claim 1, wherein the bioseparation apparatus is capable of separating one biological fluid component from another biological fluid component.

32. A separation unit comprising a plurality of hollow fiber membranes, wherein at least one of the plurality of membranes comprises a membrane formed from either a poly arylene polymer or copolymer comprising a zwitterionic group, or a poly arylene ether polymer or copolymer comprising a zwitterionic group.
